(19) United States
(12) Patent Application Publication
(10) Pub. No.: US 2023/0022246 A1
(43) Pub. Date: Jan. 26, 2023

(54) METHOD OF MAKING FUNCTIONALIZED POLYIMIDE AND POLYIMIDE RESULTING THEREFROM

(71) Applicant: SHPP Global Technologies B.V., BERGEN OP ZOOM (NL)

(72) Inventors: Dadasaheb V. PATIL, Evansville, IN (US); Prakash SISTA, Evansville, IN (US)

(21) Appl. No.: 17/433,517

(22) PCT Filed: Feb. 25, 2020
(86) PCT No.: PCT/US2020/019618

§ 371 Date: Aug. 24, 2021

(30) Foreign Application Priority Data
Feb. 25, 2019 (EP) 19159165.0

(51) Int. Cl. C08L 79/08; C08G 73/10

(52) U.S. Cl. CPC C08L 79/08; C08G 73/1017

(57) ABSTRACT

A polyimide composition, comprising a functionalized polyimide prepared from a substituted or unsubstituted C₄₋₄₀ bisanhydride; a substituted or unsubstituted C₁₋₄₀ organic diamine; and optionally an organic compound comprising at least two functional groups per molecule, wherein a first functional group is reactive with an anhydride group, an amine group, or a combination thereof, and the first functional group is different from a second functional group, wherein the functionalized polyimide comprises a reactive end group of the formula (C₁₋₄₀ hydrocarbylene)-NH₂, (C₁₋₄₀ hydrocarbylene)-OH, (C₁₋₄₀ hydrocarbylene)-SH, (C₄₋₄₀ hydrocarbylene)-G, or a combination thereof, wherein G is an anhydride group, a carboxylic acid, a carboxylic ester, or a combination thereof, wherein the functionalized polyimide has a total reactive end group concentration of 50-1,500 μeq/g of the functionalized polyimide, and wherein the polyimide composition has 0.05-1,000 ppm of residual organic diamine, wherein the functionalized polyimide is obtained by precipitation from a solution using an organic anti-solvent or by devolatilization.

### CROSS REFERENCE TO RELATED APPLICATION

This application claims the benefit of European Patent Application No. 19159165.0, filed Feb. 25, 2019, the entire content of which is incorporated by reference herein.

### BACKGROUND

Polyimides, in particular polyetherimides (PEI) are amorphous, transparent, high performance polymers having a glass transition temperature (T_{g}) of greater than 180° C. Polyetherimides further have high strength, toughness, heat resistance, and modulus, and broad chemical resistance, and so are widely used in industries as diverse as automotive, telecommunication, aerospace, electrical/electronics, transportation, and healthcare. Polyetherimides have shown versatility in various manufacturing processes, proving amenable to techniques including injection molding, extrusion, and thermoforming, to prepare various articles.

However, polyimides are typically high viscosity materials and the high viscosity, combined with the high T_{g}, can hinder their use in certain manufacturing operations, such as the manufacture of composites and coatings. For example, because of the high T_{g} of polyimides, formation of intricate parts or highly conformal coatings requires high temperatures that may not be compatible with other components. In addition, higher viscosity can limit the wetting ability of a polymer melt when applied to a substrate, resulting in coatings having voids or improper adhesion. Composites, coatings, and thin films are currently manufactured using polymer solutions containing organic solvents, which adds removal and recycling costs. Residual solvent can be a further issue in certain applications, particularly the electronics industry. Residual levels of monomers such as amines, thiols, and anhydrides are generally not favorable for further material handling and disposal. Furthermore, thermoset materials including polyimide additives suffer from poor stability in organic solvent.

There accordingly remains a need for polyimides and polyetherimides having improved properties, in particular functionalized polyimides having high T_{g} and low viscosity, and with reduced levels of byproducts, including residual solvent and monomer.

### BRIEF DESCRIPTION

According to an aspect, a polyimide composition comprises a functionalized polyimide prepared from a substituted or unsubstituted C₄₋₄₀ bisanhydride; a substituted or unsubstituted C₁₋₄₀ organic diamine; and optionally an organic compound comprising at least two functional groups per molecule, wherein a first functional group is reactive with an anhydride group, an amine group, or a combination thereof, and the first functional group is different from a second functional group, wherein the functionalized polyimide comprises a reactive end group of the formula (C₁₋₄₀ hydrocarbylene)-NH₂, (C₁₋₄₀ hydrocarbylene)-OH, (C₁₋₄₀ hydrocarbylene)-SH, (C₄₋₄₀ hydrocarbylene)-G, or a combination thereof, wherein G is an anhydride group, a carboxylic acid, a carboxylic ester, or a combination thereof, wherein the functionalized polyimide has a total reactive end group concentration of 50 to 1,500 microequivalents per gram (μeq/g), preferably 50 to 1,000 μeq/g, more preferably 50 to 750 μeq/g of the functionalized polyimide, and wherein the polyimide composition has 0.05 to 1,000 ppm by weight, preferably 0.05 to 500 ppm by weight, more preferably 0.05 to 250 ppm by weight of residual organic diamine, based on the total weight of the polyimide composition, and wherein the functionalized polyimide is obtained by precipitation from a solution using an organic anti-solvent or by devolatilization.

Another aspect provides a functionalized polyimide prepared from a substituted or unsubstituted C₄₋₄₀ bisanhydride, a substituted or unsubstituted C₁₋₄₀ organic diamine, and optionally an organic compound, wherein the organic compound comprises at least two functional groups per molecule, a first functional group is reactive with an anhydride group, an amine group, or a combination thereof, and the first functional group is different from a second functional group, wherein the functionalized polyimide comprises a reactive end group of the formula (C₁₋₄₀ hydrocarbylene)-NH₂, (C₁₋₄₀ hydrocarbylene)-OH, (C₁₋₄₀ hydrocarbylene)-SH, (C₄₋₄₀ hydrocarbylene)-G, or a combination thereof, wherein G is an anhydride group, a carboxylic acid, a carboxylic ester, or a combination thereof, wherein the functionalized polyimide has a total reactive end group concentration of 50 to 1,500 μeq/g, preferably 50 to 1,000 μeq/g, more preferably 50 to 750 μeq/g of the functionalized polyimide, and wherein the polyimide composition has 0.05 to 1,000 ppm by weight, preferably 0.05 to 500 ppm by weight, more preferably 0.05 to 250 ppm by weight of residual organic diamine, based on the total weight of the polyimide composition.

In another aspect, a method for producing the functionalized polyimide comprises reacting the substituted or unsubstituted C₄₋₄₀ bisanhydride, the substituted or unsubstituted C₁₋₄₀ organic diamine, and optionally the organic compound under reaction conditions effective to provide a functionalized polyimide.

In still another aspect, a curable composition comprises the functionalized polyimide and a thermosetting component.

### DETAILED DESCRIPTION

The present inventors have discovered lower molecular weight, functionalized polyimide oligomers can be prepared that incorporate specific amounts of functionalized end groups. The reactive functionalities allow for the use of the functionalized polyimide in a cured thermoset resin, for example by incorporation into the thermoset matrix thereby improving the chemical resistance of the cured thermoset resin. The lower molecular weight of the functionalized polyimide permits higher loadings to achieve improved mechanical properties such as toughness, impact strength, and elastic modulus in cured thermoset materials. Functionalized polyimide powders having a maximum particle size of less than 1,000 micrometers can further improve the processing with thermoset compositions. The disclosed methods also provide functionalized polyimides having lower amounts of unreacted monomers such as para-aminophenol and meta-phenylenediamine, which enhances the stability of curable compositions and reduces the increase in viscosity during processing and reduces potential health hazards during handling.

Accordingly, one aspect of the present disclosure is a polyimide composition, comprising a functionalized polyimide prepared from a substituted or unsubstituted C₄₋₄₀ bisanhydride; a substituted or unsubstituted C₁₋₄₀ organic diamine; and optionally an organic compound comprising at least two functional groups per molecule. The functionalized polyimide comprises a reactive end group of the formula (C₁₋₄₀ hydrocarbylene)-NH₂, (C₁₋₄₀ hydrocarbylene)-OH, (C₁₋₄₀ hydrocarbylene)-SH, (C₁₋₄₀ hydrocarbylene)-G, or a combination thereof, wherein G is an anhydride group, a carboxylic acid, a carboxylic ester, or a combination thereof, and has a total reactive end group concentration of 50 to 1,500 microequivalents per gram (μeq/g), preferably 50 to 1,000 μeq/g, more preferably 50 to 750 μeq/g of the functionalized polyimide. The polyimide composition includes 0.05 to 1,000 ppm by weight, preferably 0.05 to 500 ppm by weight, more preferably 0.05 to 250 ppm by weight of residual organic diamine, based on the total weight of the polyimide composition

As used herein, the term “carboxylic acids” includes carboxylate salts. The corresponding cation may be an organic or inorganic cation. Exemplary cations include, for example, ammonium, phosphonium, sodium, potassium, lithium, or the like.

The functionalized polyimide comprises a reactive end group of the formula (C₁₋₄₀ hydrocarbylene)-NH₂, (C₁₋₄₀ hydrocarbylene)-OH, (C₁₋₄₀ hydrocarbylene)-SH, (C₁₋₄₀ hydrocarbylene)-G, or a combination thereof, wherein G is an anhydride group, a carboxylic acid, a carboxylic ester, or a combination thereof. In an aspect, the functionalized polyimide comprises a reactive end group of the formula (C₁₋₄₀ hydrocarbylene)-NH₂, (C₁₋₄₀ hydrocarbylene)-SH, (C₁₋₄₀ hydrocarbylene)-G, or a combination thereof, wherein G is an anhydride group, a carboxylic acid, a carboxylic ester, or a combination thereof. In still another aspect, the functionalized polyimide comprises a reactive end group of the formula (C₁₋₄₀ hydrocarbylene)-NH₂, (C₄₋₄₀ hydrocarbylene)-G, or a combination thereof, wherein G is an anhydride group, a carboxylic acid, a carboxylic ester, or a combination thereof.

Exemplary C₁₋₄₀ hydrocarbylenes include a substituted or unsubstituted C₁₋₄₀ alkylene or a substituted or unsubstituted C₆₋₄₀ arylene. Preferably, the C₁₋₄₀ hydrocarbylene is a substituted or unsubstituted C₁₋₁₀ alkylene or a substituted or unsubstituted C₆₋₄₀ arylene.

The total reactive end group concentration is 50 to 1,500 microequivalents per gram (μeq/g), preferably 50 to 1,000 μeq/g, more preferably 50 to 750 μeq/g of the functionalized polyimide.

As used herein, the reactive end groups are groups that can interact with another polymer or prepolymer to promote the formation of cross-linking networks through chemical or physical bonding during curing and/or to promote the formation of phase-separated polyimide domains with morphology conducive to imparting toughness to the cured thermoset polymer. The reactive end groups are bonded to the atoms of the polyimide chain as chain end groups.

The concentration of end groups can be analyzed by various titration and spectroscopic methods well known in the art. Spectroscopic methods include, infrared, nuclear magnetic resonance, Raman spectroscopy, and fluorescence. Examples of infrared methods are described in J. A. Kreuz, et al., and J. Poly. Sci. Part A-1, vol. 4, pp. 2067-2616 (1966). Examples of titration methods are described in Y. J. Kim, et al., Macromolecules, vol. 26, pp. 1344-1358 (1993). It may be advantageous to make derivatives of polymer end groups to enhance measurement sensitivity using, for example, variations of methods as described in K. P. Chan et al., Macromolecules, vol. 27, p. 6731 (1994) and J. S. Chao, Polymer Bull., vol. 17, p. 397 (1987). In some aspects, the reactive end group concentration is determined by nuclear magnetic resonance spectroscopy.

The functionalized polyimide can be prepared from a C₄₋₄₀ bisanhydride of formula (1)

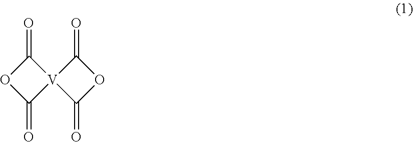

wherein each V is the same or different, and is a substituted or unsubstituted tetravalent C₄₋₄₀ hydrocarbon group, for example a substituted or unsubstituted C₆₋₂₀ aromatic hydrocarbon group, a substituted or unsubstituted C₅₋₂₀ heteroaromatic group, a substituted or unsubstituted, straight or branched chain, saturated or unsaturated C₄₋₂₀ aliphatic group, or a substituted or unsubstituted C₄₋₈ cycloaliphatic group, in particular a substituted or unsubstituted C₆₋₂₀ aromatic hydrocarbon group. The tetravalent C₄₋₄₀ hydrocarbon group optionally can include 1 to 3 heteroatoms. Exemplary aromatic hydrocarbon groups include any of those of the formulas

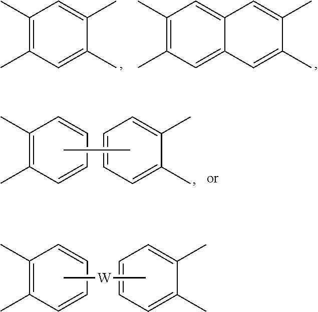

wherein W is a single bond, —O—, —S—, —C(O)—, —SO₂—, —SO—, a C₁₋₁₈ hydrocarbylene group that can be cyclic, acyclic, aromatic, or non-aromatic, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (which includes perfluoroalkylene groups), or a group of the formula —O—Z—O— as described below for formula (5a). The functionalized polyimide can be prepared from a single bisanhydride or from a combination of two or more different bisanhydrides.

Illustrative examples of C₄₋₄₀ bisanhydrides include 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; and 4-(2,3-dicarboxyphenoxy)-4′-(3,4-dicarboxyphenoxy)diphenyl sulfone dianhydride.

The C₁₋₄₀ organic diamine is of formula (2)

H₂N—R—NH₂ (2)

wherein R is a substituted or unsubstituted divalent C₁₋₄₀ or C₁₋₂₀ organic group, such as a C₆₋₂₀ aromatic hydrocarbon group or a halogenated derivative thereof, a substituted or unsubstituted, straight or branched chain C₁₋₄₀ alkylene group, such as a C₂₋₂₀ alkylene group, or a substituted or unsubstituted C₃₋₈ cycloalkylene group, or in particular a divalent group of formulas (2a)

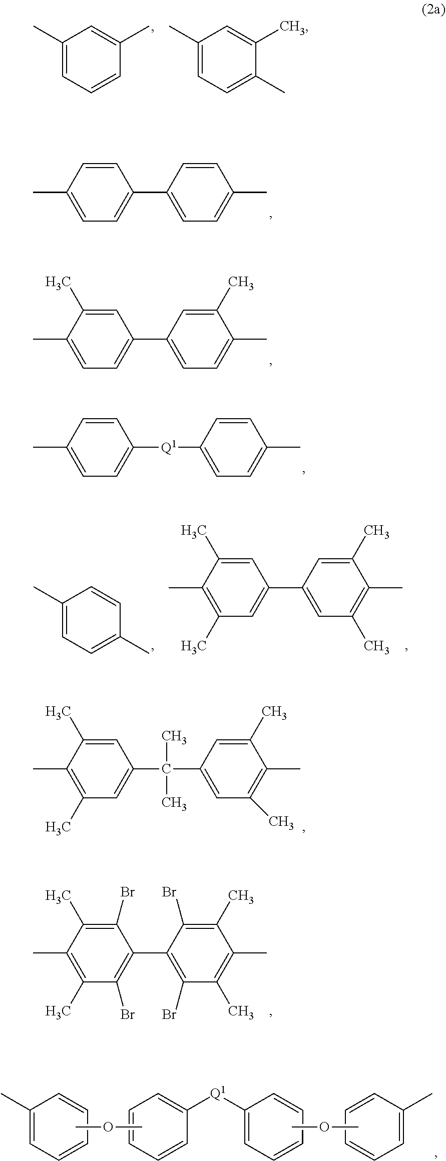

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In some aspects R is m-phenylene, p-phenylene, o-phenylene; a diarylene sulfone, in particular bis(4,4′-phenylene)sulfone, bis(3,4′-phenylene)sulfone, or bis(3,3′-phenylene)sulfone; or a diarylene ether, in particular bis(4,4′-phenylene)ether, bis(3,4′-phenylene)ether, or bis(3,3′-phenylene)ether. The functionalized polyimide can be prepared from a single organic diamine or from a combination of two or more different organic diamines.

Exemplary C₁₋₄₀ organic diamines include ethylene diamine, propylene diamine, hexamethylenediamine, polymethylated 1,6-n-hexanediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylene-diamine, 2,5-dimethylheptamethylenediamine, 2, 2-dimethylpropylene-diamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl)methane, m-phenylenediamine, p-phenylenediamine, o-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1, 3-diamino-4-isopropylbenzene, oxydianiline, bis(aminophenoxy)phenyl) sulfone, bis(4-aminophenyl) sulfide, bis-(4-aminophenyl) sulfone (also known as 4,4′-diaminodiphenyl sulfone (DDS)), and bis(4-aminophenyl) ether. The C₁₋₄₀ organic diamine can be m-phenylenediamine, p-phenylenediamine, 4,4′-diaminodiphenyl sulfone, 4,4′-oxydianiline, bis(4-(4-aminophenoxy)phenyl) sulfone, or a combination thereof.

The optional organic compound includes at least two functional groups per molecule. The first functional group is reactive with an anhydride, an amine, or a combination thereof, and the first functional group is different from a second functional group. For example, the organic compound can be of formula (3)

R^{c}-Lₙ-Q²-Lₙ-R^{d} (3)

wherein R^{c} and R^{d} are different, and are each independently —OH, —NH₂, —SH, or an anhydride group, a carboxylic acid, or a carboxylic ester. In formula (3), each L is the same or different, and are each independently a substituted or unsubstituted C₁₋₁₀ alkylene or a substituted or unsubstituted C₆₋₂₀ arylene; Q² is —O—, —S—, —S(O)—, —SO₂—, —C(O)—, or a C₁₋₂₀ organic bridging group, preferably a substituted or unsubstituted C₁₋₁₀ alkylene or a substituted or unsubstituted C₆₋₂₀ arylene, and each n is independently 0 or 1. It is to be understood that formula (3) is limited to chemically viable organic compounds, as would be understood to the person of skill in the art. For example, the organic compound may not be HO—O—OH, and hence if Q is —O— then n is 1 in formula (3).

Exemplary organic compounds include para-aminophenol, meta-aminophenol, ortho-aminophenol, 4-hydroxy-4′-aminodiphenylpropane, 4-hydroxy-4′-aminodiphenylmethane, 4-amino-4′-hydroxydiphenyl sulfone, 4-hydroxy-4′-aminodiphenyl ether, 2-hydroxy-4-aminotoluene, 4-aminothiophenol, 3-aminothiophenol, 2-aminothiophenol, 4-hydroxyphthalic anhydride, 3-hydroxyphthalic anhydride, 6-amino-2-naphthol, 5-amino-2-naphthol, 8-amino-2-naphthol, and 3-amino-2-naphthol, or the like. More than one organic compound can be used. As prepared, the functionalized polyimides comprise more than 1, for example 10 to 1000, or 10 to 500, structural units of formula (4)

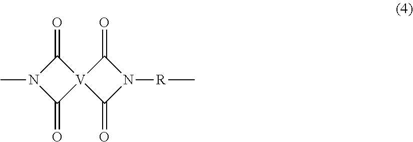

wherein each V is the same or different and is as defined in formulas (1) and (2). Further in formula (4), each R is the same or different, and is as defined above. In some aspects, at least 10 mole percent or at least 50 mole percent of the R groups contain sulfone groups, and in other aspects no R groups contain sulfone groups.

In particular aspects, the functionalized polyimide can be a functionalized polyetherimide prepared from a C₄₋₄₀ bisanhydride of formula (1a)

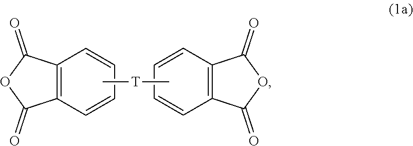

a C₁₋₄₀ organic diamine, and optionally an organic compound, wherein T is a single bond, —O—, —S—, —S(O)—, —S(O)₂—, —C(O)—, or a C₁₋₁₈ organic bridging group, or a group of the formula —O—Z—O— wherein the divalent bonds of the —O—, —S—, —S(O)—, —C(O)—, —S(O)₂—, a C₁₋₁₈ organic bridging group or the —O—Z—O— group are in the 3,3′-, 3,4′-, 4,3′-, or the 4,4′- positions, and Z is as defined below in formula (5a).

Polyetherimides are a class of polyimides that comprise more than 1, for example 10 to 1000, or 10 to 500, structural units of formula (5) or (5a)

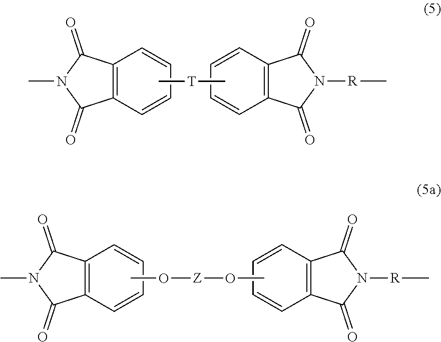

wherein each R is the same or different and is as defined in formula (2).

The group Z in —O—Z—O— of formula (5a) is a substituted or unsubstituted divalent organic group, and can be an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded. Exemplary groups Z include groups derived from a dihydroxy compound of formula (6)

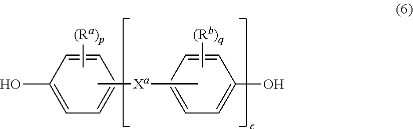

wherein R^{a} and R^{b} can be the same or different and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (6a)

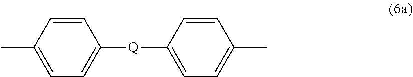

wherein Q is —O—, —S—, —C(O)—, —SO₂—, —SO—, or —C_{y}H_{2y}— wherein y is an integer from 1 to 5 or a halogenated derivative thereof (including a perfluoroalkylene group). In a specific aspect Z is a derived from bisphenol A, such that Q in formula (6a) is 2,2-isopropylidene.

In an aspect in formula (5a), R is m-phenylene or o-phenylene, p-phenylene and Z is a divalent group of formula (6a). Alternatively, R is m-phenylene, o-phenylene, or p-phenylene, Z is a divalent group of formula (6a), and Q is 2,2-isopropylidene.

In some aspects, the polyetherimide can be a copolymer, for example, a polyetherimide sulfone copolymer comprising structural units of formula (5a) wherein at least 50 mole % of the R groups are of formula (2a) wherein Q¹ is —SO₂— and the remaining R groups are independently p-phenylene, m-phenylene, or a combination thereof; and Z is 2,2′-(4-phenylene)isopropylidene.

Alternatively, the polyetherimide copolymer optionally comprises additional structural imide units, for example imide units of formula (4) wherein R and V are as described in formulas (1) and (2), for example V is

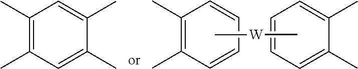

wherein W is a single bond, —O—, —S—, —C(O)—, —SO₂—, —SO—, a C₁₋₁₈ hydrocarbon moiety that can be cyclic, acyclic, aromatic, or non-aromatic, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (which includes perfluoroalkylene groups). These additional structural imide units preferably comprise less than 20 mol %, preferably 0 to 10 mol % or 0 to 5 mol % of the total number of units. In some aspects, no additional imide units are present in the polyetherimide.

The functionalized polyimides also include poly(siloxane-imide) copolymers comprising polyimide units of formula (4) or (5), preferably of formula (5a) and siloxane blocks of formula (7)

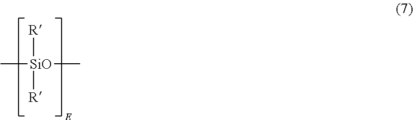

wherein E has an average value of 2 to 100, 2 to 31, 5 to 75, 5 to 60, 5 to 15, or 15 to 40, each R′ is independently a C₁₋₁₃ monovalent hydrocarbyl group. For example, each R′ can independently be a C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkyl, C₇₋₁₃ arylalkoxy, C₇₋₁₃ alkylaryl, or C₇₋₁₃ alkylaryloxy group, optionally halogenated. In an aspect, no bromine or chlorine is present, and in another aspect no halogens are present. Combinations of the foregoing R groups can be used in the same copolymer. In an aspect, the polysiloxane blocks comprises R′ groups that have minimal hydrocarbon content, such as a methyl group.

The poly (siloxane-imide)s can be prepared from a bisanhydride (1) and an organic diamine (2) or mixture of organic diamines, and a polysiloxane diamine of formula (8)

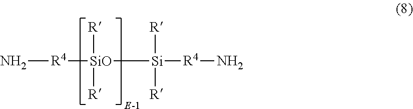

wherein R′ and E are as described in formula (7), and R⁴ is each independently a C₂-C₂₀ hydrocarbon, in particular a C₂-C₂₀ arylene, alkylene, or arylenealkylene group. In an aspect R⁴ is a C₂-C₂₀ alkylene group, and E has an average value of 5 to 100, 5 to 60, or 15 to 40. The diamine component can contain 10 to 90 mol %, or 20 to 50 mol %, or 25 to 40 mol % of polysiloxane diamine (8) and 10 to 90 mol %, or 50 to 80 mol %, or 60 to 75 mol % of organic diamine (2), for example as described in U.S. Pat. No. 4,404,350. The poly(siloxane-imide) copolymer can be a block, random, or graft copolymer.

Examples of specific poly(siloxane-imide)s are described in U.S. Pat. Nos. 4,404,350, 4,808,686 and 4,690,997. In an aspect, the poly(siloxane imide) is a poly(siloxane-etherimide) and has units of formula (9)

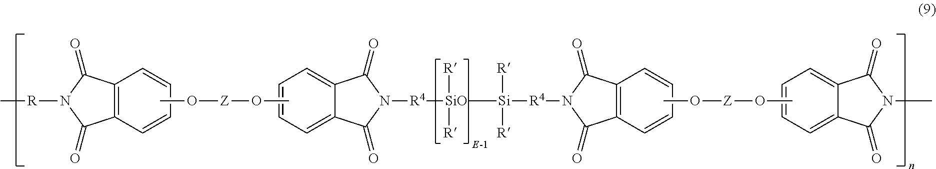

wherein R′ and E of the siloxane are as in formula (7), the R and Z of the imide are as in formulas (1) and (2), R⁴ is the same as R⁴ as in formula (8), and n is an integer from 5 to 100. In a specific aspect, the R of the etherimide is a phenylene, Z is a residue of bisphenol A, R⁴ is n-propylene, E is 2 to 50, 5, to 30, or 10 to 40, n is 5 to 100, and each R′ is methyl.

The relative amount of polysiloxane units and imide units in the poly(siloxane-imide) depends on the desired properties and are selected using the guidelines provided herein. In an aspect the poly(siloxane-imide) comprises 10 to 50 wt %, 10 to 40 wt %, or 20 to 35 wt % polysiloxane units, based on the total weight of the poly(siloxane-imide).

In some aspects, the functionalized polyimide is not a poly(siloxane-imide) copolymer. For example, the functionalized polyimide does not comprise a poly(siloxane-imide copolymer).

The functionalized polyimide can be prepared by reacting the substituted or unsubstituted C₄₋₄₀ bisanhydride, the substituted or unsubstituted C₁₋₄₀ organic diamine, and optionally the organic compound under reaction conditions effective to provide the functionalized polyimide. For example, the functionalized polyimide can be prepared by polycondensation of the bisanhydride and the organic diamine.

The bisanhydride and organic diamine can be reacted in substantially equimolar amounts or with the amine or bisanhydride in molar excess. The term “substantially equimolar amounts” means a molar ratio of bisanhydride to organic diamine of 0.9 to 1.1, preferably 0.95 to 1.05, and more preferably 0.98 to 1.02. Exemplary molar excess can be described by a molar ratio of bisanhydride to organic diamine of less than or equal to 26, preferably less than or equal to 20, more preferably less than or equal to 15; or 2 to 26, preferably 5 to 26, more preferably 10 to 26.

Conditions effective to provide the polyimide can include a temperature of 170 to 380° C., and a solids content of 1 to 50 wt %, preferably 20 to 40 wt %, more preferably 25 to 35 wt %. Polymerizations can be carried out for 2 to 24 hours (hr), preferably 3 to 16 hr. The polymerization can be conducted at reduced, atmospheric, or high pressure.

In an aspect, the reaction can be performed in a first solvent to provide a mixture of the functionalized polyimide and the first solvent, or a functionalized polyimide-solvent mixture. In some aspects, the reaction in the first solvent provides a solution of the functionalized polyimide in the first solvent, for example a homogenous solution of the functionalized polyimide in the first solvent.

The first solvent is an inert nonpolar organic solvent or an inert polar solvent that does not deleteriously affect the reaction. The first solvent can be any solvent in which the functionalized polyimide is chemically stable and has a solubility of greater than 5 grams per liter (g/L). Exemplary first solvents include veratrole, ortho-dichlorobenzene (ODCB), para-dichlorobenzene (PDCB), meta-dichlorobenzene (MDCB), N-methyl pyrrolidone (NMP), chloroform, anisole, dichlorotoluene, trichlorobenzene, tetrachlorobenzene, tetrahydrofuran (THF), dimethylformamide (DMF), dichloromethane (DCM), dimethylacetamide (DMAc), dimethyl carbonate (DMC), diethyl carbonate (DEC), ethyl methyl carbonate (EMC), ethylene carbonate (EC), dimethyl sulfoxide (DMSO), dimethyl sulfone, diphenyl sulfone, sulfolane, diphenyl ether, phenetole, hexafluoro-2-propanol (HFIP), trichloroethane (TCHE), tetrachloroethane, trifluoroacetic acid (TFA), phenol (e.g., 4-chloro-3-methyl-phenol, 4-chloro-2-methyl-phenol, 2,4-dichloro-6-methyl-phenol, 2,4-dichloro-phenol, 2,6-dichloro-phenol, 4-chloro-phenol, 2-chloro-phenol, 4-methoxy-phenol), cresol (e.g., ortho-cresol, meta-cresol, para-cresol), benzoquinone, xylenol (e.g., 2,3-xylenol, 2,6-xylenol), dihydroxybenzene (e.g., catechol, resorcinol), n-Ethyl-2-pyrrolidone (NEP), 1-ethenyl-2-pyrrolidone (NVP), 2-pyrrolidone (2-Py), 1,3-dimethyl-2-imidazolidinone (DMI), benzonitrile, dipropylene glycol dimethyl ether (DPGME), or a combination thereof. The first solvent can include one or more solvents, with the proviso that the solvents are miscible.

The functionalized polyimide-solvent mixture, for example the solution of the functionalized polyimide in the first solvent, can be contacted with a second solvent, also known as an organic anti-solvent, under conditions effective to isolate the functionalized polyimide by precipitation. In an aspect, the polyimide-solvent mixture is not a slurry as described in US 2006/0270825. For example, the functionalized polyimide-solvent mixture can have a polyimide concentration of up to 50%, preferably up to 40%, more preferably up to 30% by weight, based on the total weight of the mixture. The second solvent can be contacted so that the resulting weight ratio of second solvent to functionalized polyimide-solvent mixture is from 20:1 to 1:1, preferably 15:1 to 1:1, more preferably 10:1 to 1:1. The contacting can be effected using agitation to effect dispersion and mixing of the functionalized polyimide-solvent mixture and the second solvent. The contacting can be at a temperature from −78° C. to 150° C. and at ambient or reduced pressure, preferably in the range of 1.3 to 100 kilopascals (kPa), preferably 26.7 to 100 kPa, more preferably 66.7 kPa to 100 kPa.

The second solvent is a material that induces precipitation of the functionalized polyimide, when the second solvent and functionalized polyimide-solvent mixture are combined. In other words, the functionalized polyimide is insoluble in the second solvent and has a solubility in the second solvent of less than 2 grams per liter (g/L) at the operating temperature of the dispersion medium, in particular less than or equal to 1 g/L, or less than or equal to 0.5 g/L, or less than or equal to 0.1 g/L. Examples of the second solvent include a C₁₋₆ alkyl alcohol, a C₃₋₆ alkyl ketone, a C₅₋₆ cycloalkyl ketone, a C₃₋₆ alkyl ester, a C₅₋₈ alkane, a C₅₋₇ cycloalkane, a C₂₋₆ aliphatic nitrile, a C₂₋₆ acyclic ether, a C₄₋₇ cyclic ether, or a combination thereof. In particular aspects, the second solvent can be methanol, isopropanol, ethyl acetate, methyl ethyl ketone, methyl isobutyl ketone, acetone, acetonitrile, tetrahydrofuran, or a combination thereof. Preferably, the second solvent is miscible in the first solvent.

The functionalized polyimide-solvent mixture can alternatively be processed under other conditions effective to isolate the functionalized polyimide. Exemplary processing includes forming a thin film of the functionalized polyimide-solvent mixture under conditions effective to volatilize the first solvent, such as at a temperature from 200 to 450° C. and at a pressure from 0.13 kPa to 102 kPa, to effect substantially complete removal of the first solvent, and optionally to remove residual water, if any, from the polymerization reaction. For example, after the first solvent is evaporated, the resulting functionalized polyimide can be heated at a temperature that is greater than the glass transition temperature, such as 250 to 400° C., preferably 300 to 350° C., more preferably 350 to 400° C.

In another aspect, the reaction includes polymerizing the substituted or unsubstituted C₄₋₄₀ bisanhydride and the substituted or unsubstituted C₁₋₄₀ organic diamine under conditions effective to provide a polyimide oligomer, and melt mixing the polyimide oligomer and the organic compound under conditions effective to provide the functionalized polyimide. For example, the melt mixing can be performed in a large volume processing equipment capable of handling viscosities of greater than 100,000 centipoise (cP), for example a wiped film evaporator or an extruder, or a combination thereof at ambient or reduced pressure. The melt mixing can be at a temperature from 150 to 450° C., preferably 200 to 400° C., more preferably 250 to 375° C. The melt mixing can be performed in an extruder operated at 50 to 500 revolutions per minute (rpm), or 50 to 400 rpm, or 50 to 350 rpm. The melt mixing can be performed for less than 15 minutes, preferably from 1 to 10 minutes, more preferably 1 to 5 minutes. The resultant functionalized polyimide is substantially free of a C₆₋₃₆ alkyl imide and aliphatic amine end-cap functionalities.

The reaction can include melt polymerizing the substituted or unsubstituted C₄₋₄₀ bisanhydride, the substituted or unsubstituted C₁₋₄₀ organic diamine, and optionally the organic compound to provide the functionalized polyimide. The melt polymerization can be performed at a temperature that is 50 to 200° C., preferably 100 to 150° C. greater than the T_{g} of the functionalized polyimide and at ambient or reduced pressure, preferably in the range of 1.3 to 100 kilopascals (kPa), more preferably 26.7 to 100 kPa, even more preferably 66.7 kPa to 100 kPa. The melt polymerization can be performed using a batch mixer, a kneader reactor, an agitated thin film evaporator, or other large volume processing equipment capable of handling viscosities of greater than 100,000 centipoise (cP). The melt polymerization can be performed in 5 minutes to 24 hours, preferably 30 minutes to 12 hours, more preferably 1 to 6 hours.

An endcapping agent can be present during the reaction, in particular a monofunctional compound that can react with an amine or anhydride. Exemplary compounds include monofunctional aromatic anhydrides such as phthalic anhydride, an aliphatic monoanhydride such as maleic anhydride, or monofunctional aldehydes, ketones, esters isocyanates, aromatic monoamines such as aniline, or C₁-C₁₈ linear or cyclic aliphatic monoamines. The amount of endcapping agent that can be added depends on the desired amount of chain terminating agent, and can be, for example, 0 to 10 mol %, or 0.1 to 10 mol %, or 0.1 to 6 mol %, based on the moles of endcapping agent and diamine or bisanhydride reactant. In an aspect, no additional endcapping agent is used to prepare the functionalized polyimide.

In some aspects, the functionalized polyimide has greater than 0.05 ppm by weight, preferably greater than 100 ppm by weight, more preferably greater than 500 ppm by weight, even more preferably greater than 1,000 ppm by weight of a non-reactive end group, based on the total weight of the functionalized polyimide.

A catalyst can be present during the reaction. Exemplary catalysts include sodium aryl phosphinates, guanidinium salts, pyridinium salts, imidazolium salts, tetra(C₇₋₂₄ arylalkylene) ammonium salts, dialkyl heterocycloaliphatic ammonium salts, bis-alkyl quaternary ammonium salts, (C₇₋₂₄ arylalkylene)(C₁₋₁₆ alkyl) phosphonium salts, (C₆₋₂₄ aryl)(C₁₋₁₆ alkyl) phosphonium salts, phosphazenium salts, and combinations thereof. The anionic component of the salt is not particularly limited, and can be, for example, chloride, bromide, iodide, sulfate, phosphate, acetate, maculate, tosylate, and the like. A combination of different anions can be used. A catalytically active amount of the catalyst can be determined by one of skill in the art without undue experimentation, and can be, for example, more than 0 to 5 mol % percent, or 0.01 to 2 mol %, or 0.1 to 1.5 mol %, or 0.2 to 1.0 mol % based on the moles of organic diamine.

In an aspect, the functionalized polyimide is prepared from a reaction mixture including 50 to 90 wt %, preferably 60 to 90 wt %, more preferably 70 to 90 wt % of the substituted or unsubstituted C₄₋₄₀ bisanhydride; 5 to 50 wt %, preferably 15 to 50 wt %, more preferably 15 to 35 wt % of the substituted or unsubstituted C₁₋₄₀ organic diamine; and 0 to 45 wt %, preferably 0 to 35 wt %, more preferably 0 to 25 wt % of the organic compound, based on the total weight of the bisanhydride, the organic diamine, and the organic compound.

In another aspect, the functionalized polyimide is prepared from a reaction mixture including 50 to 90 wt %, preferably 60 to 90 wt %, more preferably 70 to 90 wt % of the substituted or unsubstituted C₄₋₄₀ bisanhydride; 5 to 50 wt %, preferably 15 to 50 wt %, more preferably 15 to 35 wt % of the substituted or unsubstituted C₁₋₄₀ organic diamine; and 1 to 45 wt %, preferably 3 to 45 wt %, more preferably 5 to 45 wt % of the organic compound, based on the total weight of the bisanhydride, the organic diamine, and the organic compound.

The functionalized polyimide can have a weight average molecular weight (M_{w}) of 5,000 to 45,000 grams per mole (g/mol), preferably 10,000 to 45,000 g/mol, more preferably 15,000 to 35,000 g/mol as determined by gel permeation chromatography (GPC) using polystyrene standards. The polydispersity (PDI) can be less than 4.5, preferably less than 4.0, more preferably less than 3.0, even more preferably less than 2.80.

The functionalized polyimide can have a maximum absolute particle size of less than 1,000 micrometers (μm), preferably less than 500 μm, more preferably less than 100 μm, even more preferably less than 75 μm. The maximum absolute particles size is defined by the pore size of the sieve used to isolate the functionalized polyimide particles and does not represent an average particle size.

The functionalized polyimide can have an average degree of reactive end group functionality of greater than 0.75, preferably greater than 0.9, more preferably greater than 1.1, even more preferably greater than 1.5. The average degree of reactive end group functionality is defined as the average number of hydroxyl, amino, and carboxylic acid end groups per polyimide chain.

The functionalized polyimide can have a glass transition temperature (T_{g}) of greater than 155° C., preferably greater than 175° C., more preferably greater than 190° C. For example, the T_{g} can be 155 to 280° C., preferably 175 to 280° C., more preferably 190 to 280° C., as determined by differential scanning calorimetry (DSC) according to ASTM D3418.

The functionalized polyimide can have an amide-acid concentration of 0.5 to 5000 microequivalents per gram (μeq/g), preferably 0.5 to 1000 μeq/g, more preferably 0.5 to 500 μeq/g of the functionalized polyimide, as determined by nuclear magnetic resonance spectroscopy. For example, the functionalized polyimide can have an amide-acid end group concentration of 0.5 to 5000 μeq/g, preferably 0.5 to 1000 μeq/g, more preferably 0.5 to 500 μeq/g of the functionalized polyimide, as determined by nuclear magnetic resonance spectroscopy.

The polyimide composition has 0.05 to 1,000 ppm, preferably 0.05 to 500 ppm, more preferably 0.05 to 250 ppm by weight of residual organic diamine, based on the total weight of the polyimide composition, as determined by ultra-performance liquid chromatography (UPLC).

The polyimide composition can include 0.05 to 5,000 ppm by weight, preferably 0.05 to 1000 ppm by weight, more preferably 0.05 to 500 ppm by weight, even more preferably 0.05 to 250 ppm of residual solvent, based on the total weight of the polyimide composition, as determined by gas chromatography.

The polyimide composition can include 0.05 to 1,000 ppm by weight, preferably 0.05 to 750 ppm by weight, more preferably 0.05 to 500 ppm by weight each of a residual bisanhydride and a residual organic compound, based on the total weight of the polyimide composition, as determined by UPLC.

As used herein, “residual bisanhydride” means the remaining substituted or unsubstituted C₄₋₄₀ bisanhydride from the preparation of the functionalized polyimide. As used herein, “residual organic compound” means the remaining organic compound, if any, from the preparation of the functionalized polyimide. As used herein, “residual diamine” means the remaining substituted or unsubstituted C₁₋₄₀ organic diamine from the preparation of the functionalized polyimide.

The polyimide composition can include 0.05 to 3,000 ppm by weight, preferably 0.05 to 2,000 ppm by weight, more preferably 0.05 to 1,000 ppm by weight, even more preferably 0.05 to 500 ppm by weight of a total content of residual bisanhydride, residual diamine, and residual organic compound, based on the total weight of the polyimide composition.

The polyimide composition can include 0.1 to 100 ppm by weight, 0.1 to 75 ppm by weight, 0.1 to 25 ppm by weight each of Na, K, Ca, Zn, Al, Cu, Ni, P, Ti, Mg, Mn, Si, Cr, Mo, Co and Fe, based on the total weight of the polyimide composition, as determined by inductively coupled plasma spectrometry.

The polyimide composition can include 0.1 to 200 ppm by weight, 0.1 to 100 ppm by weight, 0.1 to 50 ppm, 0.1 to 25 ppm by weight of a total content of Na, K, Ca, Zn, Al, Cu, Ni, P, Ti, Mg, Mn, Si, Cr, Mo, Co and Fe, based on the total weight of the polyimide composition, as determined by inductively coupled plasma spectrometry.

The polyimide composition can include 0.3 to 500 ppm by weight, 0.3 to 250 ppm by weight each of phosphate, nitrate, nitrite, sulfate, bromide, fluoride, and chloride, based on the total weight of the polyimide composition, as determined by total ion chromatography combustion.

The functionalized polyimide can have greater than 0.05 ppm by weight, preferably greater than 100 ppm by weight, more preferably greater than 500 ppm by weight, even more preferably greater than 1,000 ppm by weight of a non-reactive end group, based on the total weight of the functionalized polyimide, as determined by nuclear magnetic resonance spectroscopy.

The polyimide compositions can further comprise additives for polyimide compositions generally known in the art, with the provision that the additive(s) are selected so as to not significantly adversely affect the desired properties of the compositions, in particular formation of the poly(imide). Such additives include a particulate filler, a fibrous filler, an antioxidant, a heat stabilizer, a light stabilizer, a ultraviolet light stabilizer, a ultraviolet light-absorbing compound, a near infrared light-absorbing compound, an infrared light-absorbing compound, a plasticizer, a lubricant, a release agent, a antistatic agent, storage stabilizer, ozone inhibitors, optical stabilizer, thickener, conductivity-impacting agent, radiation interceptor, nucleating agent, an anti-fog agent, an antimicrobial agent, a metal inactivating agent, a colorant, a surface effect additive, a radiation stabilizer, a flame retardant, an anti-drip agent, a fragrance, an adhesion promoter, a flow enhancer, a coating additive, a polymer different from the one or more epoxy resins, or a combination thereof. The total amount of the additive composition can be 0.001 to 20 wt %, or 0.01 to 10 wt %, based on the total weight of the polyimide composition.

The functionalized polyimide can be further processed to obtain a powder having a specified maximum particle size. Processing includes grinding, milling, cryo grinding, sieving, and combinations thereof. The processed polyimide powder has a weight average molecular weight, PDI, and reactive end group content that corresponds to the functionalized polyimide because processing does not affect these properties. The processed powder can be sieved to attain a desired maximum particle size. In one aspect, the maximum size is 1,000 μm. In another aspect, a maximum absolute particle size of 1 to 1,000 micrometers, preferably 1 to 500 micrometers, more preferably 1 to 100 micrometers, even more preferably 1 to 75 micrometers, as determined by pore size of a sieve used to isolate the functionalized polyimide

The functionalized polyimide can also be blended with other polymers to form a polymer blend. Polymers that can be used include polyacetals, poly(meth)acrylates, poly(meth)acrylonitriles, polyamides, polycarbonates, polydienes, polyesters, polyethers, polyetherether ketones, polyetherimides, polyethersulfones, polyfluorocarbons, polyfluorochlorocarbons, polyimides, poly(phenylene ether), polyketones, polyolefins, polyoxazoles, polyphosphazenes, polysiloxanes, polystyrenes, polysulfones, polyurethanes, polyvinyl acetates, polyvinyl chlorides, polyvinylidene chlorides, polyvinyl esters, polyvinyl ethers, polyvinyl ketones, polyvinyl pyridines, polyvinyl pyrrolidones, and copolymers thereof, for example polyetherimide siloxanes, ethylene vinyl acetates, acrylonitrile-butadiene-styrene, or a combination thereof. Preferably, the functionalized polyimide can be combined with another polymer such as polyarylate, polyamide, polyimide, polyetherimide, poly(amide imide), poly(aryl ether), phenoxy resins, poly(aryl sulfone), poly(ether sulfone), poly(phenylene sulfone), poly(ether ketone), poly(ether ether ketone), poly(ether ketone ketone), poly(aryl ketone), poly(phenylene ether), polycarbonate, carboxyl-terminated butadiene-acrylonitrile (CTBN), amine-terminated butadiene-acrylonitrile (ATBN), epoxy-terminated butadiene-acrylonitrile (ETBN), core-shell rubber particles, or a combination thereof.

The functionalized polyimide can also be incorporated into a curable composition. The curable composition comprises the functionalized polyimide (or polyimide composition) and a thermosetting component. In an aspect, the curable composition includes the functionalized polyimide, another polymer different from the functionalized polyimide, and a thermosetting component. The thermosetting component can comprise epoxy components, phenol/formaldehyde components, bismaleimide components, cyanoacrylate components, polyurethane prepolymers, and combinations thereof. More specifically the thermosetting component can comprise epoxy component, bismaleimide component, cyanoacrylate component, or a combination thereof. The epoxy component may be selected from epoxy compounds having a broad range of structures and molecular weights as long as it contains at least two glycidyl groups per molecule. Exemplary epoxy components include aliphatic, cycloaliphatic and aromatic epoxy compounds, as well as combinations of the foregoing.

Exemplary cycloaliphatic epoxy compounds include vinyl cyclohexane dioxide, 4(1,2 epoxy ethyl) 1,2 epoxy cyclohexane, 3,4 epoxy cyclohexylmethyl (3,4 epoxy) cyclohexane carboxylate, and 2-(3,4 epoxy) cyclohexyl-5,5 spiro(3,4-epoxy)-cyclohexane-m-dioxane. Exemplary aromatic epoxy compounds include: resorcinol diglycidyl ether (or 1,3-bis(2,3-epoxy propoxy)benzene); diglycidyl ether of bisphenol A (or 2,2-bis(4-(2,2-bis(4-(2,3-epoxypropoxy)3-bromophenyl) propane); diglycidyl ether of bisphenol F; triglycidyl p-aminophenol (or 4-(2,3-epoxypropoxy)-N,N-bis(2,3-epoxypropyl)aniline); diglycidyl ether of bromobisphenol A (or 2,2-bis(4-(2,2-bis(4-(2,3-epoxypropoxy)3-bromophenyl) propane); diglycidyl ether of bisphenol F (or 2,2-bis(p-(2,3-epoxypropoxy-phenyl)methane); triglycidyl ether of meta-aminophenol (or 3-(2,3-epoxypropoxy)-N,—N-bis12,3-epoxypropyl)aniline); tetraglycidyl methylene diaminodiphenyl methane); N,N,N′,N′-tetraglycidyl-4,4′-bisbenzenamine; low viscosity epoxy cresol resins, and low viscosity epoxy novolac resins. The curable composition may further comprise a curing agent. Exemplary curing agents include phenolic resins, acid anhydrides, amines, and imidazoles. The curable composition is typically heated to effect curing and result in a thermoset composite.

Also provided are articles comprising the functionalized polyimide. The articles can include a composite, an adhesive, a film, a layer, a coating, an encapsulant, a sealant, a component, a prepreg, a laminate, a casing, a molded parts, or a combination thereof.

This disclosure is further illustrated by the following examples, which are non-limiting.

### EXAMPLES

The components in Table 1 were used to prepare Examples 1 to 4 or as comparative examples.

TABLE 1

| Component | Description | CAS Reg. No. | Source |
|---|---|---|---|
| BPADA | 2,2-bis[4-(3,4-dicarboxyphenoxy)phenyl]propane dianhydride | 38103-06-9 | SABIC |
| | (4,4′-Bisphenol A dianhydride) | | |
| mPD | m-Phenylenediamine | 108-45-2 | SABIC |
| PAP | p-Aminophenol | 204-616-2 | Sigma Aldrich |
| oDCB | Ortho-Dichlorobenzene | 95-50-1 | Fisher Scientific |
| MeOH | Methanol | 67-56-1 | Fisher Scientific |
| DCM | Methylene chloride | 75-09-2 | Fisher Scientific |
| PEI | Polyetherimide comprising structural units derived from | 61128-46-9 | SABIC |
| | bisphenol A dianhydride and m-phenylene diamine, and | | |
| | having a weight average molecular weight (M_{w}) of 44 kg/mol | | |
| | as determined by GPC using polystyrene standard, and a | | |
| | particle size of less than 300 pm (sieved); obtained as ULTEM | | |
| | 1010 | | |
| PESU | Chloro- and hydroxy-functionalized polyethersulfone, M_{w} = | 25135-51-7 | Solvay |
| | 43.2 kg/mol as determined by GPC using polystyrene | | |
| | standard, OH end groups of 80 μeq/g, particle size of less than | | |
| | 300 μm (as sieved) | | |

In the following examples, M_{w} and Mₙ are determined by GPC using polystyrene standards unless indicated otherwise.

### Comparative Example 1

The procedure used to prepare amine-terminated PEI oligomer is described in Example 1 of U.S. Pat. No. US2006/0270825, and modified as follows: 50.05 grams (g) of BPA-DA (94.6 mmol), 14.6 g of mPD (134.5 mmol), and 200 g of oDCB were used. As the reaction was heated to 175° C., a clear, homogenous solution was formed (rather than a homogenous slurry) throughout the temperature ramp. Once the targeted molecular weight was obtained, the mixture was allowed to cool to room temperature. Cooling of this reaction mixture resulted in a more viscous solution which could not be filtered under vacuum filtration to isolate desired product in the powder form. Filtration attempts were unsuccessful leading to plugging of the filter paper.

### Example 1. Synthesis of Amine-Terminated PEI Oligomer

To an oven-dried, 3-neck, 500 mL round-bottomed flask equipped with a mechanical stirrer, nitrogen adapter and Dean-Stark condenser was added 50.06 grams (g) of BPA-DA (94.6 mmol), 14.6 g of mPD (134.5 mmol), and 200 g of oDCB. The oil bath temperature was increased to 180° C. and the reaction was refluxed at this temperature for 3 to 4 hours. A small sample was withdrawn for molecular weight measurement. The reaction was stoichiometrically corrected with DA or amine to obtain targeted M. Once the M_{w} was achieved, the reaction mixture was allowed to cool to room temperature (ca. 25° C.) and then 150 g of dichloromethane (alternatively, similar quantities of oDCB can be used) was added thereto, and the contents were vigorously stirred to provide an oligomer solution. The oligomer solution was slowly added into a 2 L beaker containing 800 to 850 mL of MeOH under high shear mixing conditions, resulting in the formation of a precipitate. The resultant fine off-white powder was filtered and washed with MeOH (2×50 mL). The isolated solids were dried in a vacuum oven at 130 to 135° C. for 12 hours to obtain the amine-terminated PEI oligomer as a powder having a M_{w} of 5,766 g/mol and polydispersity index (PDI) of 2.37.

### Example 2. Synthesis of Amine-Terminated PEI Oligomer

Following the same procedure as in Example 1, 50 g of BPA-DA (94.17 mmol), 12.40 g of mPD (114.67 mmol), and 200 g of oDCB yielded an amine-terminated PEI oligomer powder having a M_{w} of 9,872 g/mol and a PDI of 2.12.

### Example 3. Synthesis of Hydroxy-Terminated PEI Oligomer

Following the same procedure as in Example 1, 56.10 g of BPA-DA (107.74 mmol), 7.80 g of mPD (72.13 mmol), 8.01 g of PAP (73.31 mmol), and 200 g of oDCB yielded a hydroxy-terminated PEI oligomer powder having a M_{w} of 4,598 g/mol and a PDI of 2.32.

### Example 4. Synthesis of Hydroxy-Terminated PEI Oligomer

Following the same procedure as in Example 1, 52.20 g of BPA-DA (97.47 mmol), 8.97 g of mPD (82.95 mmol), 3.50 g of PAP (32.07 mmol), and 200 g of oDCB yielded a hydroxy-terminated PEI oligomer powder having a M_{w} of 9,214 g/mol and a PDI of 2.42.

### Example 5. Synthesis of Amine-Terminated PEI Oligomer

Following the same procedure as in Example 1, 65 g of BPA-DA (121.56 mmol), 14.83 g of mPD (137.14 mmol), and 230 g of oDCB yielded an amine-terminated PEI oligomer powder having a M_{w} of 17,819 g/mol and a PDI of 2.42.

### Example 6. Synthesis of Amine-Terminated PEI Oligomer

Following the same procedure as in Example 1, 65 g of BPA-DA (121.37 mmol), 14.12 g of mPD (130.57 mmol), and 230 g of oDCB yielded an amine-terminated PEI oligomer powder having a M_{w} of 26,180 g/mol and a PDI of 2.36.

### Example 7. Synthesis of Amine-Terminated PEI Oligomer

Following the same procedure as in Example 1, 64.8 g of BPA-DA (121.00 mmol), 13.84 g of mPD (127.99 mmol), and 230 g of oDCB yielded an amine-terminated PEI oligomer powder having a M_{w} of 32,968 g/mol and a PDI of 2.35.

### Example 8. Synthesis of Amine-Terminated PEI Oligomer

A vessel maintained under a nitrogen atmosphere and equipped with a mechanical agitator, a condenser, and a hot oil jacket was charged with 1 equivalent of BPA-DA, 1.16 equivalents of mPD, and oDCB to maintain percent solids between 25-50%. The reaction mixture was heated to 180-190° C. and the reaction was heated at this temperature for 3 to 4 hours as the water of imidization and some solvent was condensed in an overhead. A small sample of the reaction mixture was withdrawn for molecular weight measurement. The reaction was stoichiometrically corrected with DA or diamine to obtain the targeted M_{w} with the desired stoichiometry. Once the target M_{w} and stoichiometry was achieved, the mixture was then devolatilized at 180 to 350° C. under vacuum. The resulting polymer agglomeration was ground into fine powder with an appropriate milling device. The isolated functionalized PEI oligomer had a molecular weight of 10,692 g/mol, a PDI of 2.86, 560 ppm of residual oDCB, 144.24 ppm of residual mPD, and amine end-group concentration of 525.7 μeq/g of the functionalized polyimide.

### Example 9. Synthesis of Amine-Terminated PEI Oligomer

A vessel maintained under a nitrogen atmosphere and equipped with a mechanical agitator, a condenser, and a hot oil jacket was charged with 1 equivalent of BPA-DA, 1.16 equivalents of mPD, and oDCB to maintain percent solids between 25-50%. The reaction mixture was heated to 180-190° C. and the reaction was heated at this temperature for 3 to 4 hours as the water of imidization and some solvent was condensed in an overhead. A small sample of the reaction mixture was withdrawn for molecular weight measurement. The reaction was stoichiometrically corrected with DA or diamine to obtain targeted M_{w} and the desired stoichiometry. Once the M_{w} and stoichiometry was achieved, the mixture was then devolatilized at 180 to 350° C. under vacuum. The resulting polymer agglomeration was ground into fine powder with an appropriate milling device. The isolated functionalized PEI oligomer had a molecular weight of 10,323 g/mol, a PDI of 2.93, 570 ppm of residual oDCB, 133.59 ppm of residual mPD, and amine end-group concentration of 540.12 μeq/g of the functionalized polyimide.

### Example 10. Synthesis of Amine-Terminated PEI Oligomer

A vessel maintained under a nitrogen atmosphere and equipped with a mechanical agitator, a condenser, and a hot oil jacket was charged with 1 equivalent of BPA-DA, 1.16 equivalents of mPD, and oDCB to maintain percent solids between 25-50%. The reaction mixture was heated to 180-190° C. and the reaction was heated at this temperature for 3 to 4 hours as the water of imidization and some solvent was condensed in an overhead. A small sample of the reaction mixture was withdrawn for molecular weight measurement. The reaction was stoichiometrically corrected with DA or diamine to obtain targeted M_{w} and the desired stoichiometry. Once the M_{w} and the desired stoichiometry was achieved, the mixture was then devolatilized at 180 to 350° C. under vacuum. The resulting polymer agglomeration was ground into fine powder using an appropriate milling device. The isolated functionalized PEI oligomer had a molecular weight of 10,414 g/mol, a PDI of 2.84, 1170 ppm of residual oDCB, and 270.73 ppm of residual mPD.

### Example 11. Synthesis of Amine-Terminated PEI Oligomer

A vessel maintained under a nitrogen atmosphere and equipped with a mechanical agitator, a condenser, and a hot oil jacket was charged with 1 equivalent of BPA-DA, 1.11 equivalents of mPD, and oDCB to maintain percent solids between 25-50%. The reaction mixture was heated to 180-190° C. and the reaction was heated at this temperature for 3 to 4 hours as the water of imidization and some solvent was condensed in an overhead. A small sample of reaction mixture was withdrawn for molecular weight measurement. The reaction was stoichiometrically corrected with DA or diamine to obtain targeted M_{w} and the desired stoichiometry. Once the M_{w} and desired stoichiometry was achieved, the mixture was then devolatilized at 180 to 350° C. under vacuum. The resulting polymer agglomeration was ground into fine powder using an appropriate milling device. The isolated functionalized PEI oligomer had a molecular weight of 22,797 g/mol, a PDI of 2.52, and amine end-group concentration of 248.91 μeq/g of the functionalized polyimide.

### Example 12. Synthesis of Amine-Terminated PEI Oligomer

A vessel maintained under a nitrogen atmosphere and equipped with a mechanical agitator, a condenser, and a hot oil jacket was charged with 1 equivalent of BPA-DA, 1.06 equivalents of mPD, and oDCB to maintain percent solids between 25-50%. The reaction mixture was heated to 180-190° C. and the reaction was heated at this temperature for 3 to 4 hours as the water of imidization and some solvent was condensed in an overhead. A small sample of the reaction mixture was withdrawn for molecular weight measurement. The reaction was stoichiometrically corrected with DA or diamine to obtain targeted M_{w} and the desired stoichiometry. Once the M_{w} and desired stoichiometry was achieved, the mixture was then devolatilized at 180 to 350° C. under vacuum. The resulting polymer agglomeration was ground into fine powder using an appropriate milling device. The isolated functionalized PEI oligomer had a molecular weight of 30,986 g/mol, a PDI of 2.36, 4574 ppm of residual oDCB, and amine end-group concentration of 165.8 μeq/g of the functionalized polyimide.

Analysis

The properties of the functionalized oligomers of Examples 1 to 4 were examined, and the results are provided in Tables 2 to 5. Weight average molecular weight (M_{w}) and number average molecular weight (Mₙ) were determined by gel permeation chromatography (GPC) using polystyrene standards. Glass transition temperature (T_{g}) was determined by differential scanning calorimetry (DSC) using the second heating cycle from 40 to 300° C. (heating rate of 20° C./min) according to ASTM D3418. Thermal stability was determined by thermal gravimetric analysis (TGA) from 40 to 800° C. (heating rate of 20° C./min) under nitrogen and air and is reported as the onset decomposition temperature at 5%, 10%, and 50% weight loss. The hydroxyl and amine end groups were identified and quantified by derivatization of the oligomers with a phosphorous reagent (o-phenylene phosphorochloridite) and quantified by phosphorous-31 nuclear magnetic resonance spectroscopy (³¹P NMR), as described in K. P. Chan et al., Macromolecules, 1994, vol. 27, p. 6371.

All residual levels of metals (sodium, potassium, calcium, zinc, aluminum, nickel, copper, phosphorous, titanium, magnesium, manganese, silicon, chromium, molybdenum, and iron) in the following examples are determined by an inductively coupled plasma-digestion (ICP-Dig) method which uses an ICP spectrometer equipped with: an axial and/or radial viewing, a Gem Cone and/or Ultrasonic nebulizer, and a microwave digestion system equipped with appropriate sample digestion vessels set. Samples are prepared using concentrated nitric acid, hydrochloric acid, sulfuric acid, and/or hydrofluoric acid-supra pure grades.

Residual levels of anions (sulfates, chlorides, bromides, fluorides, phosphates, nitrates, nitrites) present in polyimide oligomer samples were measured by extraction-ion chromatography (IC-Extract). The polyimide oligomer samples were dissolved in methylene chloride. The solutions were then extracted with deionized water, and then the aqueous extracts were analyzed by total ion chromatography combustion (IC-Total).

Table 2 provides the molecular weights for the PEI oligomers before and after precipitation using the anti-solvent (MeOH).

TABLE 2

| | Before Precipitation | | | After Precipitation | | |
|---|---|---|---|---|---|---|
| | Mn | Mw | | Mn | Mw | |
| Sample | (g/mol) | (g/mol) | PDI | (g/mol) | (g/mol) | PDI |
| Example 1 | 2167 | 4693 | 2.16 | 2430 | 5766 | 2.37 |
| Example 2 | 4506 | 9686 | 2.14 | 4654 | 9872 | 2.12 |
| Example 3 | 1826 | 4632 | 2.53 | 1980 | 4598 | 2.32 |
| Example 4 | 4498 | 9585 | 2.22 | 3809 | 9214 | 2.42 |
| Example 5 | 6923 | 16615 | 2.40 | 7354 | 17819 | 2.42 |
| Example 6 | 11061 | 25415 | 2.29 | 11051 | 26180 | 2.36 |
| Example 7 | 14526 | 32489 | 2.23 | 14009 | 32968 | 2.35 |

The results in Table 2 indicated an increase in molecular weight upon precipitation for the amino-terminated PEI oligomers of Examples 1 and 2, and a decrease in molecular weight for the hydroxyl-terminated PEI oligomers of Examples 3 and 4. Further analysis of the filtrate containing the blend of oDCB, DCM, and MeOH indicated that lower molecular weight species and unreacted monomers were being removed in the process of precipitation and product isolation. An amine analysis by UPLC method showed less than 1 ppm of residual amine present in the antisolvent from the precipitated oligomer products.

Table 3 provides the glass transition temperatures for the PEI oligomers and comparative oligomers.

TABLE 3

| Sample | Tg (° C.) |
|---|---|
| Example 1 | 156.84 |
| Example 2 | 180.03 |
| Example 3 | 176.04 |
| Example 4 | 181.32 |
| Example 5 | 198.8 |
| Example 6 | 206.2 |
| Example 7 | 210.8 |
| PEI | 217 |
| PESU | 231.7 |

Examples 2 and 4 revealed comparable glass transition temperatures (Tg) for the amino- and hydroxyl-terminated PEI oligomers. A similar trend was not observed for Examples 1 and 3, and the lower molecular weight amine-terminated PEI oligomer had a Tg that was nearly 20° C. lower than the lower molecular weight hydroxyl-terminated PEI oligomer. Further, as the molecular weight of amino-terminated PEI oligomers increased, an increase in glass transition temperature (T_{g}) was seen. The Tg for the comparative PEI polymer and polyether sulfone (PESU) oligomers were greater than for Examples 1 to 7, due to their higher molecular weights.

Table 4 shows the thermal stability for the PEI oligomers and comparative oligomers.

TABLE 4

| | Air, Onset Loss (° C.) | | | Nitrogen, Onset Loss (° C.) | | |
|---|---|---|---|---|---|---|
| Sample | 5% | 10% | 50% | 5% | 10% | 50% |
| Example 1 | 365 | 489 | 638 | 350 | 483 | 637 |
| Example 2 | 463 | 529 | 636 | 468 | 521 | 659 |
| Example 3 | 426 | 473 | 628 | 417 | 450 | 605 |
| Example 4 | 391 | 470 | 630 | 375 | 452 | 613 |
| PEI | 548 | 557 | 646 | 546 | 553 | 672 |
| PESU | 511 | 543 | 618 | 495 | 531 | 591 |

Thermogravimetric analysis was used to determine the onset temperatures at which 5%, 10%, and 50% weight loss occurs. The onset temperatures for 5% and 10% weight loss from the PEI oligomers of Examples 1 to 4 were less than those for the comparative PEI and PESU oligomers. Surprisingly, the lower molecular weight hydroxyl-terminated PEI oligomer (Example 3) had higher onset temperatures for 5% and 10% weight loss, respectively, compared to the higher molecular weight hydroxyl-terminated PEI oligomer (Example 4). The opposite trend was observed for the amino-terminated PEI oligomers, with Example 1 having lower onset temperatures for 5% and 10% weight loss, respectively, compared with Example 2. In summary, Examples 1 to 4 were found to have good thermal stability at high temperatures (>350° C.).

Table 5 shows the reactive end group analysis for the PEI oligomers of Examples 1 to 4 (where “ND” refers to not detected).

TABLE 5

| | | | COOH | | |
|---|---|---|---|---|---|
| Sample | NH₂ (μeq/g) | OH (μeq/g) | (μeq/g) | M_{w} (g/mol) | T_{g} (° C.) |
| Example 1 | 854.1 | ND | 0.87 | 5,766 | 156.8 |
| Example 2 | 524.7 | ND | 0.91 | 9,872 | 180.0 |
| Example 3 | 1.1 | 880.8 | 48.7 | 4,598 | 176.0 |
| Example 4 | 11.8 | 472.8 | 1.04 | 9,214 | 181.3 |
| Example 5 | 238.4 | ND | ND | 17,819 | 198.8 |
| Example 6 | 136.1 | ND | ND | 26,180 | 206.2 |
| Example 7 | 84.9 | ND | ND | 32,968 | 210.8 |

Phosphorous functionalization of the reactive end groups of the PEI oligomers was used to quantify the end groups of the PEI oligomers of Examples 1 to 4 by ³¹P NMR spectroscopy. The amine-terminated oligomers of Examples 1 and 2 demonstrated two different peaks in the NMR spectra, corresponding to aromatic amines and carboxylic acids. The hydroxyl-terminated oligomers of Examples 3 and 4 demonstrated three different peaks, corresponding to aromatic amines, carboxylic acids, and phenols (hydroxyl groups). In the amino-terminated PEI oligomers of Examples 1 and 2, the quantity of aromatic amino end groups decreased as the molecular weight increased. Similarly, in the hydroxyl-terminated PEI oligomers of Examples 3 and 4, the quantity of hydroxyl end groups decreased as the molecular weight increased.

This disclosure further encompasses the following aspects, which are non-limiting.

Aspect 1. A polyimide composition, comprising a functionalized polyimide prepared from a substituted or unsubstituted C₄₋₄₀ bisanhydride; a substituted or unsubstituted C₁₋₄₀ organic diamine; and optionally an organic compound comprising at least two functional groups per molecule, wherein a first functional group is reactive with an anhydride group, an amine group, or a combination thereof, and the first functional group is different from a second functional group, wherein the functionalized polyimide comprises a reactive end group of the formula (C₁₋₄₀ hydrocarbylene)-NH₂, (C₁₋₄₀ hydrocarbylene)-OH, (C₁₋₄₀ hydrocarbylene)-SH, (C₄₋₄₀ hydrocarbylene)-G, or a combination thereof, wherein G is an anhydride group, a carboxylic acid, a carboxylic ester, or a combination thereof, wherein the functionalized polyimide has a total reactive end group concentration of 50 to 1,500 microequivalents per gram, preferably 50 to 1,000 microequivalents per gram, more preferably 50 to 750 microequivalents per gram of the functionalized polyimide, and wherein the polyimide composition has 0.05 to 1,000 ppm by weight, preferably 0.05 to 500 ppm by weight, more preferably 0.05 to 250 ppm by weight of residual organic diamine, based on the total weight of the polyimide composition, and wherein the functionalized polyimide is obtained by precipitation from a solution using an organic anti-solvent or by devolatilization.

Aspect 2. The polyimide composition of aspect 1, wherein the polyimide composition comprises one or more of: 0.05 to 1,000 ppm by weight, preferably 0.05 to 500 ppm by weight, more preferably 0.05 to 250 ppm by weight of residual solvent, based on the total weight of the polyimide composition; 0.05 to 1,000 ppm by weight, preferably 0.05 to 750 ppm by weight, more preferably 0.05 to 500 ppm by weight each of residual bisanhydride and a residual organic compound, based on the total weight of the polyimide composition; 0.05 to 3,000 ppm by weight, preferably 0.05 to 2,000 ppm by weight, more preferably 0.05 to 1,000 ppm by weight, even more preferably 0.05 to 500 ppm by weight of a total content of residual bisanhydride, residual organic diamine, and residual organic compound, based on the total weight of the polyimide composition; 0.1 to 100 ppm by weight, 0.1 to 75 ppm by weight, 0.1 to 25 ppm by weight each of sodium, potassium, calcium, zinc, aluminum, nickel, copper, phosphorous, titanium, magnesium, manganese, silicon, chromium, cobalt, and iron, based on the total weight of the polyimide composition; 0.1 to 200 ppm by weight, 0.1 to 100 ppm by weight, 0.1 to 50 ppm, 0.1 to 25 ppm by weight of a total content of sodium, potassium, calcium, zinc, aluminum, nickel, copper, phosphorous, titanium, magnesium, manganese, silicon, chromium, cobalt, and iron, based on the total weight of the polyimide composition; or 0.3 to 50 ppm by weight, preferably 0.3 to 25 ppm by weight each of phosphate, nitrate, nitrite, sulfate, bromide, fluoride, and chloride, based on the total weight of the polyimide composition.

Aspect 3. A functionalized polyimide prepared from a substituted or unsubstituted C₄₋₄₀ bisanhydride, a substituted or unsubstituted C₁₋₄₀ organic diamine, and optionally an organic compound, wherein the organic compound comprises at least two functional groups per molecule, a first functional group is reactive with an anhydride group, an amine group, or a combination thereof, and the first functional group is different from a second functional group, wherein the functionalized polyimide comprises a reactive end group of the formula (C₁₋₄₀ hydrocarbylene)-NH₂, (C₁₋₄₀ hydrocarbylene)-OH, (C₁₋₄₀ hydrocarbylene)-SH, (C₄₋₄₀ hydrocarbylene)-G, or a combination thereof, wherein G is an anhydride group, a carboxylic acid, a carboxylic acid ester, or a combination thereof, wherein the functionalized polyimide has a total reactive end group concentration of 50 to 1,500 microequivalents per gram, preferably 50 to 1,000 microequivalents per gram, more preferably 50 to 750 microequivalents per gram of the functionalized polyimide, and wherein the polyimide composition has 0.05 to 1,000 ppm by weight, preferably 0.05 to 500 ppm by weight, more preferably 0.05 to 250 ppm by weight of residual organic diamine, based on the total weight of the polyimide composition.

Aspect 4. The functionalized polyimide of aspect 3, wherein the functionalized polyimide comprises one or more of: a weight average molecular weight of 5,000 to 45,000 grams per mole, preferably 10,000 to 45,000 g/mol, more preferably 15,000 to 35,000 g/mol as determined by GPC; a maximum absolute particle size of less than 1,000 μm, preferably less than 500 μm, more preferably less than 100 μm, even more preferably less than 75 micrometers, as determined by pore size of a sieve used to isolate the functionalized polyimide; an average degree of reactive end group functionality of greater than 0.75, preferably greater than 0.9, more preferably greater than 1.1, even more preferably greater than 1.5, wherein average degree of reactive end group functionality is defined as the average number of hydroxyl, amino, and carboxylic acid end groups per polyimide chain; a glass transition temperature of 155 to 280° C., preferably 175 to 280° C., more preferably 190 to 280° C., as determined by differential scanning calorimetry according to ASTM D3418; an amide-acid concentration of 0.5 to 5000 microequivalents per gram, preferably 0.5 to 1000 μeq/g, more preferably 0.5 to 500 μeq/g of the functionalized polyimide; a polydispersity of less than 4.5, preferably less than 4.0, more preferably less than 3.0, even more preferably less than 2.80, as determined by gel permeation chromatography using polystyrene standards; or the functionalized polyimide has greater than 0.05 ppm by weight, preferably greater than 100 ppm by weight, more preferably greater than 500 ppm by weight, even more preferably greater than 1,000 ppm by weight of a non-reactive end group, based on the total weight of the functionalized polyimide.

Aspect 5. The functionalized polyimide of any one or more of the preceding aspects, wherein the polyimide comprises units of formula (4) as provided herein.

Aspect 6. The functionalized polyimide of aspect 5, wherein each R is independently a divalent group of formulas (2a) as provided herein; and each V is independently a tetravalent group of the formula

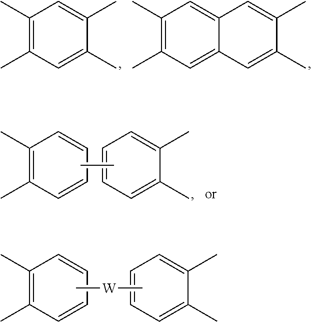

wherein W is as provided herein, or a group of the formula —O—Z—O—, and Z is a group of the formula

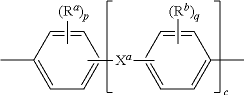

wherein R^{a} and R^{b} are as provided herein.

Aspect 7. The functionalized polyimide of any one or more of the preceding aspects, wherein the polyimide is a polyetherimide that comprises units of formula (5a) wherein R and Z are as defined in aspect 6.

Aspect 8. A method for producing the functionalized polyimide of any one or more of the preceding aspects, the method comprising: reacting the substituted or unsubstituted C₄₋₄₀ bisanhydride, the substituted or unsubstituted C₁₋₄₀ organic diamine, and optionally the organic compound under reaction conditions effective to provide a functionalized polyimide.

Aspect 9. The method of aspect 8, wherein the reacting is performed in a first solvent to provide a mixture of the functionalized polyimide and the first solvent, and the method further comprises: processing the mixture under conditions effective to isolate the functionalized polyimide; or contacting the mixture with a second solvent under conditions effective to isolate the functionalized polyimide by precipitation.

Aspect 10. The method of aspect 9, wherein the first solvent is dichlorobenzene, N-methylpyrrolidone, dimethylacetamide, dimethylformamide, chlorobenzene, anisole, veratrole, dichlorotoluene, trichlorobenzene, diphenyl sulfone, diphenylether, phenetole, dimethylsulfoxide, dimethyl sulfone, sulfolane, cresol, benzonitrile, or a combination thereof; preferably wherein the first solvent is ortho-dichlorobenzene.

Aspect 11. The method of aspect 9 or 10, wherein the second solvent is a C₁₋₆ alkyl alcohol, a C₃₋₆ alkyl ketone, a C₅₋₆ cycloalkyl ketone, a C₃₋₆ alkyl ester, a C₅₋₈ alkane, a C₅₋₇ cycloalkane, a C₂₋₆ aliphatic nitrile, a C₂₋₆ acyclic ether, a C₄₋₇ cyclic ether, water, or a combination thereof; preferably wherein the second solvent is methanol, isopropanol, ethyl acetate, methyl ethyl ketone, methyl isobutyl ketone, acetone, acetonitrile, tetrahydrofuran, or a combination thereof.

Aspect 12. The method of aspect 8, wherein the reacting comprises: polymerizing the substituted or unsubstituted C₄₋₄₀ bisanhydride and the substituted or unsubstituted C₁₋₄₀ organic diamine under conditions effective to provide a polyimide oligomer; and melt mixing the polyimide oligomer and the organic compound under conditions effective to provide the functionalized polyimide.

Aspect 13. The method of aspect 8, wherein the reacting comprises melt polymerizing the substituted or unsubstituted C₄₋₄₀ bisanhydride, the substituted or unsubstituted C₁₋₄₀ organic diamine, and optionally the organic compound to provide the functionalized polyimide.

Aspect 14. The method of any one or more of the preceding aspects, wherein the organic compound is of the formula R^{c}-Lₙ-Q²-Lₙ-R^{d} wherein R^{c} and R^{d} are the different, and are each independently —OH, —NH₂, —SH, or an anhydride group, a carboxylic acid, or a carboxylic ester, each L is the same or different, and are each independently a substituted or unsubstituted C₁₋₁₀ alkylene or a substituted or unsubstituted C₆₋₂₀ arylene, Q² is —O, S, S(O)—, —SO₂—, —C(O), or a C₁₋₄₀ organic bridging group, preferably a substituted or unsubstituted C₁₋₁₀ alkylene or a substituted or unsubstituted C₆₋₂₀ arylene, and each n is independently 0 or 1; more preferably wherein the organic compound is para-aminophenol, meta-aminophenol, ortho-aminophenol, 4-hydroxy-4′-aminodiphenylpropane, 4-hydroxy-4′-aminodiphenylmethane, 4-amino-4′-hydroxydiphenyl sulfone, 4-hydroxy-4′-aminodiphenyl ether, 2-hydroxy-4-aminotoluene, 4-aminothiophenol, 3-aminothiophenol, 2-aminothiophenol, 4-hydroxyphthalic anhydride, 3-hydroxyphthalic anhydride, 6-amino-2-naphthol, 5-amino-2-naphthol, 8-amino-2-naphthol, 3-amino-2-naphthol, or a combination thereof.

Aspect 15. A curable composition comprising the functionalized polyimide of any one or more of the preceding aspects and a thermosetting component.

The compositions, methods, and articles can alternatively comprise, consist of, or consist essentially of, any appropriate components or steps herein disclosed. The compositions, methods, and articles can additionally, or alternatively, be formulated so as to be devoid, or substantially free, of any steps, components, materials, ingredients, adjuvants, or species that are otherwise not necessary to the achievement of the function or objectives of the compositions, methods, and articles.

The singular forms “a,” “an,” and “the” include plural referents unless the context clearly dictates otherwise. “Or” means “and/or” unless clearly indicated otherwise by context. The terms “first,” “second,” and the like, do not denote any order, quantity, or importance, but rather are used to distinguish one element from another. Reference throughout the specification to “an aspect” means that a particular element described in connection with the aspect is included in at least one aspect described herein, and may or may not be present in other aspects. The described elements can be combined in any suitable manner in the various aspects. “Combinations” is inclusive of blends, mixtures, alloys, reaction products, and the like. “Combination thereof” as used herein is an open term and refers to a combination comprising one or more of the listed items, optionally with one or more like items not listed.

All ranges disclosed herein are inclusive of the endpoints, and the endpoints are independently combinable with each other. The endpoints of all ranges directed to the same component or property are inclusive and independently combinable. Disclosure of a narrower range or more specific group in addition to a broader range is not a disclaimer of the broader range or larger group.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

As used herein, the term “hydrocarbyl” includes groups containing carbon, hydrogen, and optionally one or more heteroatoms (e.g., 1, 2, 3, or 4 atoms such as halogen, 0, N, S, P, or Si). “Alkyl” means a branched or straight chain, saturated, monovalent hydrocarbon group, e.g., methyl, ethyl, i-propyl, and n-butyl. “Alkylene” means a straight or branched chain, saturated, divalent hydrocarbon group (e.g., methylene (—CH₂—) or propylene (—(CH₂)₃—)). “Alkenyl” and “alkenylene” mean a monovalent or divalent, respectively, straight or branched chain hydrocarbon group having at least one carbon-carbon double bond (e.g., ethenyl (—HC═CH₂) or propenylene (—HC(CH₃)═CH₂—). “Alkynyl” means a straight or branched chain, monovalent hydrocarbon group having at least one carbon-carbon triple bond (e.g., ethynyl). “Alkoxy” means an alkyl group linked via an oxygen (i.e., alkyl-O—), for example methoxy, ethoxy, and sec-butyloxy. “Cycloalkyl” and “cycloalkylene” mean a monovalent and divalent cyclic hydrocarbon group, respectively, of the formula —CₙH₂ₙ₋ₓ and —CₙH₂ₙ₋₂ₓ— wherein x is the number of cyclization(s). “Aryl” means a monovalent, monocyclic, or polycyclic aromatic group (e.g., phenyl or naphthyl). “Arylene” means a divalent, monocyclic, or polycyclic aromatic group (e.g., phenylene or naphthylene). “Arylene” means a divalent aryl group. “Alkylaryl” means an aryl group substituted with an alkyl group. “Arylalkyl” means an alkyl group substituted with an aryl group (e.g., benzyl). The prefix “halo” means a group or compound including one more halogen (F, Cl, Br, or I) substituents, which can be the same or different. The prefix “hetero” means a group or compound that includes at least one ring member that is a heteroatom (e.g., 1, 2, or 3 heteroatoms), wherein each heteroatom is independently N, O, S, or P.

Unless substituents are otherwise specifically indicated, each of the foregoing groups can be unsubstituted or substituted, provided that the substitution does not significantly adversely affect synthesis, stability, or use of the compound. “Substituted” means that the compound, group, or atom is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkyl (e.g., benzyl), C₇₋₁₂ alkylaryl (e.g., toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the substituted atom's normal valence is not exceeded, and that the substitution does not significantly adversely affect the manufacture, stability, or desired property of the compound. The number of carbon atoms indicated in a group is exclusive of any substituents. For example —CH₂CH₂CN is a C₂ alkyl group substituted with a nitrile.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A polyimide composition, comprising a functionalized polyimide prepared from
a substituted or unsubstituted C₄₋₄₀ bisanhydride;
a substituted or unsubstituted C₁₋₄₀ organic diamine; and
optionally an organic compound comprising at least two functional groups per molecule, wherein a first functional group is reactive with an anhydride group, an amine group, or a combination thereof, and the first functional group is different from a second functional group,
wherein the functionalized polyimide comprises a reactive end group of the formula (C₁₋₄₀ hydrocarbylene)-NH₂, (C₁₋₄₀ hydrocarbylene)-OH, (C₁₋₄₀ hydrocarbylene)-SH, (C₄₋₄₀ hydrocarbylene)-G, or a combination thereof,
wherein G is an anhydride group, a carboxylic acid, a carboxylic ester, or a combination thereof,
wherein the functionalized polyimide has a total reactive end group concentration of 50 to 1,500 microequivalents per gram of the functionalized polyimide, as determined by nuclear magnetic resonance spectroscopy, and
wherein the polyimide composition has 0.05 to 1,000 ppm by weight of residual organic diamine, based on the total weight of the polyimide composition, as determined by ultra-performance liquid chromatography, and
wherein the functionalized polyimide is obtained by precipitation from a solution using an organic anti-solvent or by devolatilization.

2. The polyimide composition of claim 1, wherein the polyimide composition comprises one or more of:
0.05 to 5,000 ppm by weight of residual solvent, based on the total weight of the polyimide composition, as determined by gas chromatography;
0.05 to 1,000 ppm by weight of residual bisanhydride and a residual organic compound, based on the total weight of the polyimide composition, as determined by ultra-performance liquid chromatography;
0.05 to 3,000 ppm by weight of a total content of residual bisanhydride, residual organic diamine, and residual organic compound, based on the total weight of the polyimide composition, as determined by ultra-performance liquid chromatography;
0.1 to 100 ppm by weight each of sodium, potassium, chromium, magnesium, manganese, cobalt, titanium, silicon, molybdenum, calcium, zinc, aluminum, nickel, copper, phosphorous, and iron, based on the total weight of the polyimide composition, as determined by inductively coupled plasma spectrometry;
0.1 to 200 ppm by weight of a total content of sodium, potassium, chromium, magnesium, manganese, cobalt, titanium, silicon, molybdenum, calcium, zinc, aluminum, nickel, copper, phosphorous, and iron, based on the total weight of the polyimide composition, as determined by inductively coupled plasma spectrometry; or
0.3 to 500 ppm by weight each of phosphate, nitrate, nitrite, sulfate, bromide, fluoride, and chloride, based on the total weight of the polyimide composition, as determined by total ion chromatography combustion.

3. A functionalized polyimide prepared from a substituted or unsubstituted C₄₋₄₀ bisanhydride, a substituted or unsubstituted C₁₋₄₀ organic diamine, and optionally an organic compound,
wherein the organic compound comprises at least two functional groups per molecule, a first functional group is reactive with an anhydride group, an amine group, or a combination thereof, and the first functional group is different from a second functional group,
wherein the functionalized polyimide comprises a reactive end group of the formula (C₁₋₄₀ hydrocarbylene)-NH₂, (C₁₋₄₀ hydrocarbylene)-OH, (C₁₋₄₀ hydrocarbylene)-SH, (C₄₋₄₀ hydrocarbylene)-G, or a combination thereof,
wherein G is an anhydride group, a carboxylic acid, a carboxylic acid ester, or a combination thereof,
wherein the functionalized polyimide has a total reactive end group concentration of 50 to 1,500 microequivalents per gram of the functionalized polyimide, as determined by nuclear magnetic resonance spectroscopy, and
wherein the polyimide composition has 0.05 to 1,000 ppm by weight of residual organic diamine, based on the total weight of the polyimide composition, as determined by ultra-performance liquid chromatography.

4. The functionalized polyimide of claim 3, wherein the functionalized polyimide comprises one or more of:
a weight average molecular weight of 5,000 to 45,000 grams per mole as determined by gel permeation chromatography using polystyrene standards;
a maximum absolute particle size of 1 to 1,000 micrometers as determined by pore size of a sieve used to isolate the functionalized polyimide;
an average degree of reactive end group functionality of greater than 0.75, wherein average degree of reactive end group functionality is defined as the average number of hydroxyl, amino, and carboxylic acid end groups per polyimide chain;
a glass transition temperature 155 to 280° C., as determined by differential scanning calorimetry according to ASTM D3418;
an amide-acid concentration of 0.5 to 5000 microequivalents per gram, as determined by nuclear magnetic resonance spectroscopy;
a polydispersity of less than 4.5; or
the functionalized polyimide has greater than 0.05 ppm by weight of a non-reactive end group, based on the total weight of the functionalized polyimide, as determined by nuclear magnetic resonance spectroscopy.

5. The functionalized polyimide of claim 3, wherein the polyimide comprises units of the formula 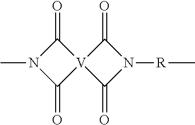
wherein
each R is the same or different and is independently a substituted or unsubstituted divalent C₁₋₂₀ organic group; and
each V is the same or different and is independently a substituted or unsubstituted tetravalent C₄₋₄₀ hydrocarbon group optionally comprising 1 to 3 heteroatoms.

6. The functionalized polyimide of claim 5, wherein
each R is independently a divalent group of the formula 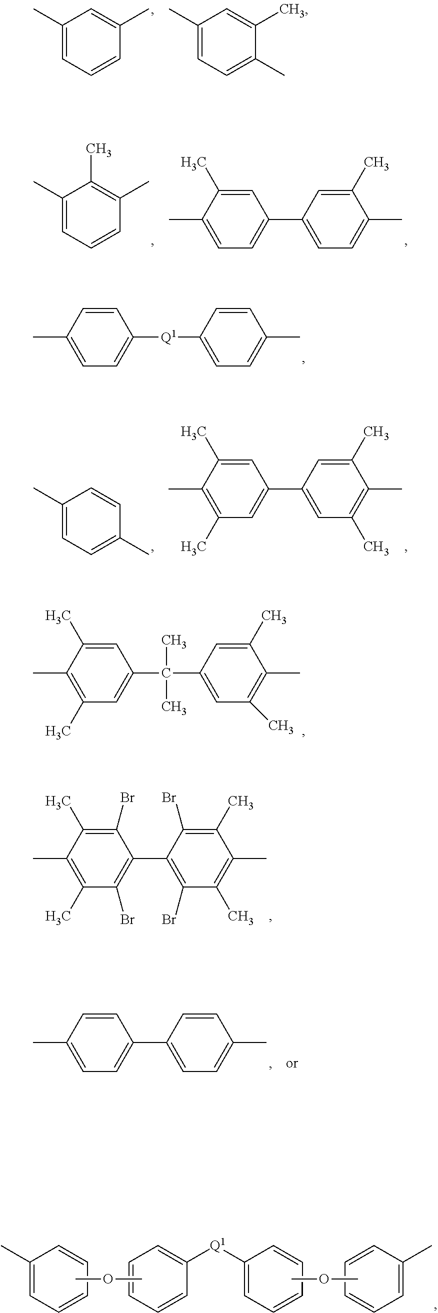
wherein
Q¹ is —O—, —S—, —C(O)—, —SO₂—, —SO—, —P(R′)(═O)— wherein R′ is a C₁₋₈ alkyl or C₆₋₁₂ aryl, —C_{y}H_{2y}— or a halogenated derivative thereof wherein y is an integer from 1 to 5, or —(C₆H₁₀)_{z}— wherein z is an integer from 1 to 4; and
each V is independently a tetravalent group of formulae: 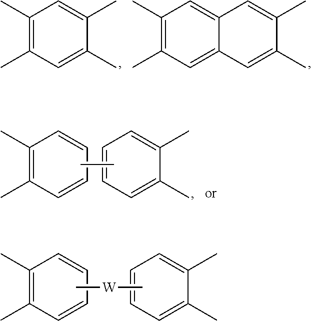
wherein
W is a single bond, —O—, —S—, —C(O)—, —SO₂—, —SO—, a C₁₋₁₈ hydrocarbylene group, —P(R′)(═O)— wherein R′ is a C₁₋₈ alkyl or C₆₋₁₂ aryl, —(C_{y}H_{2y})— wherein y is an integer from 1 to 5 or a halogenated derivative thereof, or a group of the formula —O—Z—O—, and
Z is a group of the formula 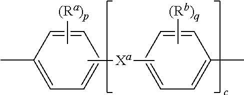
wherein
R^{a} and R^{b} are each independently a halogen atom or a monovalent C₁₋₆ alkyl group,
p and q are each independently integers of 0 to 4,
c is 0 to 4, and
X^{a} is a single bond, —O—, —S—, —S(O)—, —SO₂—, —C(O)—, or a C₁₋₁₈ organic bridging group.

7. The functionalized polyimide of claim 3, wherein the polyimide is a polyetherimide that comprises units of the formula 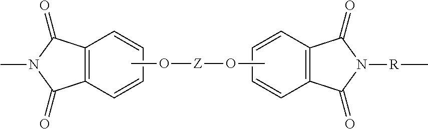
wherein,
each R is independently a divalent group of formulae: 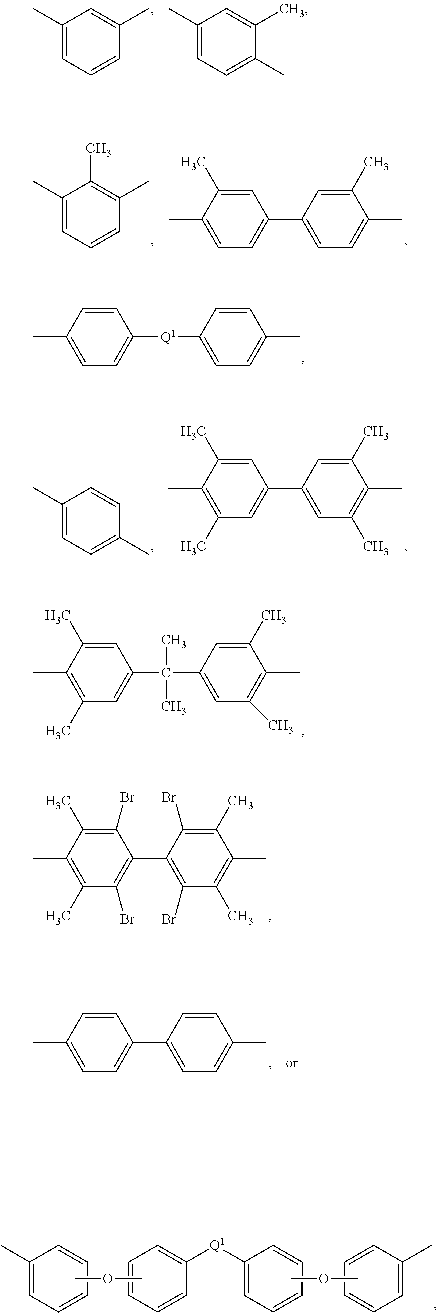
wherein
Q¹ is —O—, —S—, —C(O)—, —SO₂—, —SO—, —P(R′)(═O)— wherein R′ is a C₁₋₈ alkyl or C₆₋₁₂ aryl, —C_{y}H_{2y}— or a halogenated derivative thereof wherein y is an integer from 1 to 5 or —(C₆H₁₀)_{z}— wherein z is an integer from 1 to 4; and
Z is a group of the formula 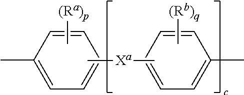
wherein
R^{a} and R^{b} are each independently a halogen atom or a monovalent C₁₋₆ alkyl group,
p and q are each independently integers of 0 to 4,
c is 0 to 4, and
X^{a} is a single bond, —O—, —S—, —S(O)—, —SO₂—, —C(O)—, or a C₁₋₁₈ organic bridging group.

8. A method for producing the functionalized polyimide of claim 3, the method comprising:
reacting the substituted or unsubstituted C₄₋₄₀ bisanhydride, the substituted or unsubstituted C₁₋₄₀ organic diamine, and optionally the organic compound under reaction conditions effective to provide the functionalized polyimide.

9. The method of claim 8, wherein the reacting is performed in a first solvent to provide a mixture of the functionalized polyimide and the first solvent, and the method further comprises:
processing the mixture under conditions effective to isolate the functionalized polyimide; or
contacting the mixture with a second solvent under conditions effective to isolate the functionalized polyimide by precipitation.

10. The method of claim 9, wherein the first solvent is dichlorobenzene, N-methylpyrrolidone, dimethylacetamide, dimethylformamide, chlorobenzene, anisole, veratrole, dichlorotoluene, trichlorobenzene, di phenyl sulfone, diphenylether, phenetole, dimethylsulfoxide, dimethyl sulfone, sulfolane, cresol, benzonitrile, or a combination thereof.

11. The method of claim 9, wherein the second solvent is a C₁₋₆ alkyl alcohol, a C₃₋₆ alkyl ketone, a C₅₋₆ cycloalkyl ketone, a C₃₋₆ alkyl ester, a C₅₋₈ alkane, a C₅₋₇ cycloalkane, a C₂₋₆ aliphatic nitrile, a C₂₋₆ acyclic ether, a C₄₋₇ cyclic ether, or a combination thereof.

12. The method of claim 8, wherein the reacting comprises:
polymerizing the substituted or unsubstituted C₄₋₄₀ bisanhydride and the substituted or unsubstituted C₁₋₄₀ organic diamine under conditions effective to provide a polyimide oligomer; and
melt mixing the polyimide oligomer and the organic compound under conditions effective to provide the functionalized polyimide.

13. The method of claim 8, wherein the reacting comprises melt polymerizing the substituted or unsubstituted C₄₋₄₀ bisanhydride, the substituted or unsubstituted C₁₋₄₀ organic diamine, and optionally the organic compound to provide the functionalized polyimide.

14. The method of claim 8, wherein the organic compound is of the formula
R^{c}-Lₙ-Q²-Lₙ-R^{d}
wherein
R^{c} and R^{d} are different, and are each independently —OH, —NH₂, —SH, or an anhydride group, a carboxylic acid, or a carboxylic ester,
each L is the same or different, and are each independently a substituted or unsubstituted C₁₋₁₀ alkylene or a substituted or unsubstituted C₆₋₂₀ arylene,
Q² is —O—, —S—, —S(O)—, —SO₂—, —C(O)—, or a C₁₋₄₀ organic bridging group and
each n is independently 0 or 1.

15. A curable composition comprising the functionalized polyimide of claim 3, and
a thermosetting component.

16. The polyimide composition of claim 1, wherein
the total reactive end group concentration is 50 to 1,000 microequivalents per gram of the functionalized polyimide, as determined by nuclear magnetic resonance spectroscopy, and
the polyimide composition has 0.05 to 500 ppm by weight of residual organic diamine, based on the total weight of the polyimide composition, as determined by ultra-performance liquid chromatography

17. The polyimide composition of claim 1, wherein the functionalized polyimide comprises units of the formula 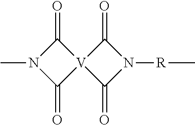
wherein
each R is the same or different and is independently a substituted or unsubstituted divalent C₁₋₂₀ organic group; and
each V is the same or different and is independently a substituted or unsubstituted tetravalent C₄₋₄₀ hydrocarbon group optionally comprising 1 to 3 heteroatoms.

18. The polyimide composition of claim 17, wherein
each R is independently a divalent group of the formula 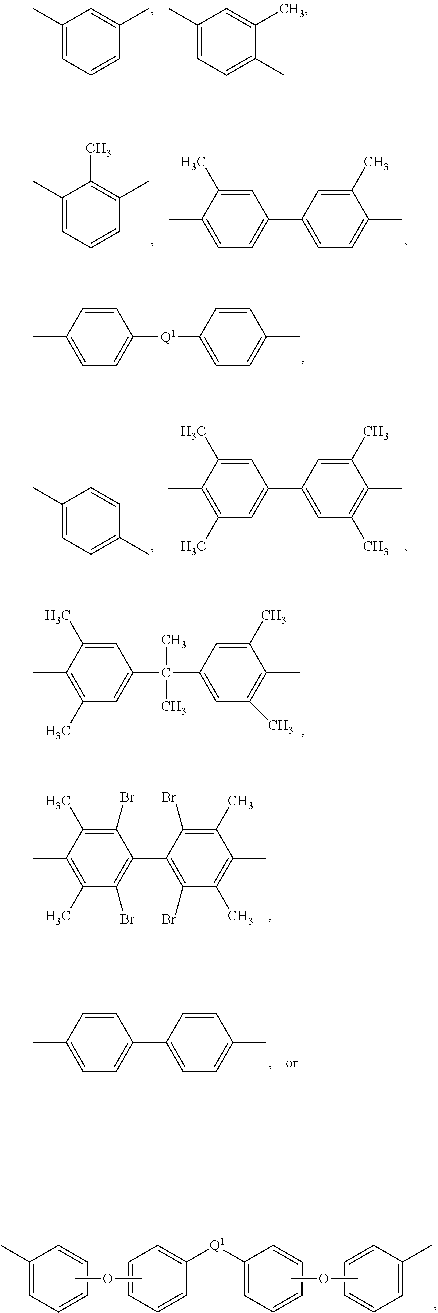
wherein
Q¹ is —O—, —S—, —C(O)—, —SO₂—, —SO—, —P(R′)(═O)— wherein R′ is a C₁₋₈ alkyl or C₆₋₁₂ aryl, —C_{y}H_{2y}— or a halogenated derivative thereof wherein y is an integer from 1 to 5, or —(C₆H₁₀)_{z}— wherein z is an integer from 1 to 4; and
each V is independently a tetravalent group of formulae: 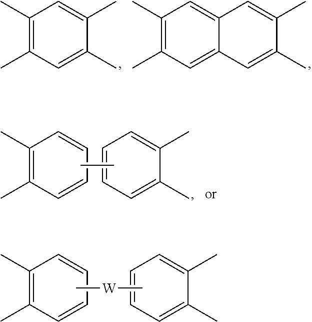
wherein
W is a single bond, —O—, —S—, —C(O)—, —SO₂—, —SO—, a C₁₋₁₈ hydrocarbylene group, —P(R′)(═O)— wherein R′ is a C₁₋₈ alkyl or C₆₋₁₂ aryl, —(C_{y}H_{2y})— wherein y is an integer from 1 to 5 or a halogenated derivative thereof, or a group of the formula —O—Z—O—, and
Z is a group of formula 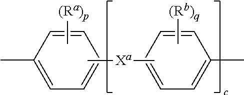
wherein
R^{a} and R^{b} are each independently a halogen atom or a monovalent C₁₋₆ alkyl group,
p and q are each independently integers of 0 to 4,
c is 0 to 4, and
X^{a} is a single bond, —O—, —S—, —S(O)—, —SO₂—, —C(O)—, or a C₁₋₁₈ organic bridging group.

19. The polyimide composition of claim functionalized polyimide of claim 1, wherein the polyimide is a polyetherimide comprising units of formula 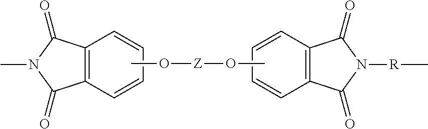
wherein,
each R is independently a divalent group of formulae: 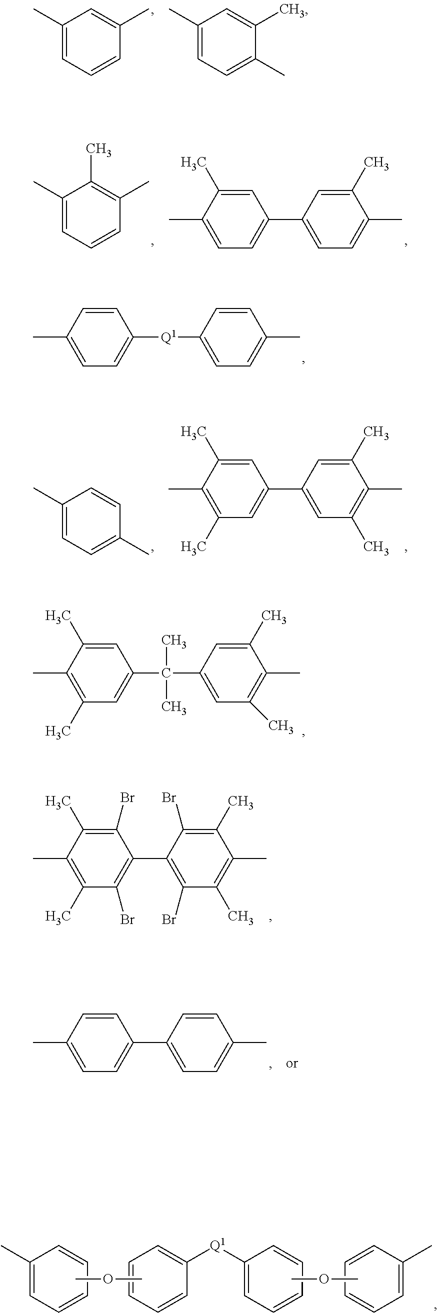
wherein
Q¹ is —O—, —S—, —C(O)—, —SO₂—, —SO—, —P(R′)(═O)— wherein R′ is a C₁₋₈ alkyl or C₆₋₁₂ aryl, C_{y}H_{2y}— or a halogenated derivative thereof wherein y is an integer from 1 to 5, or —(C₆H₁₀)_{z}— wherein z is an integer from 1 to 4; and
Z is a group of the formula 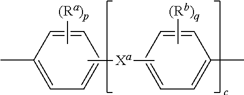
wherein
R^{a} and R^{b} are each independently a halogen atom or a monovalent C₁₋₆ alkyl group,
p and q are each independently integers of 0 to 4,
c is 0 to 4, and
X^{a} is a single bond, —O—, —S—, —S(O)—, —SO₂—, —C(O)—, or a C₁₋₁₈ organic bridging group.

20. The method of claim 8, wherein the functionalized polyimide comprises units of the formula 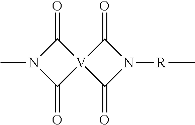
wherein
each R is the same or different and is independently a substituted or unsubstituted divalent C₁₋₂₀ organic group; and
each V is the same or different and is independently a substituted or unsubstituted tetravalent C₄₋₄₀ hydrocarbon group optionally comprising 1 to 3 heteroatoms.
